(19) United States
(12) Patent Application Publication
(10) Pub. No.: US 2025/0091911 A1
(43) Pub. Date: Mar. 20, 2025

(54) NANOFILTRATION SYSTEM AND METHOD INCLUDING PRETREATMENT WITH GREEN SORPTION MEDIA

(71) Applicant: University of Central Florida Research Foundation, Inc., Orlando, FL (US)

(72) Inventors: Ni-Bin Chang, Orlando, FL (US); A H M Anwar Sadmani, Orlando, FL (US)

(21) Appl. No.: 18/830,799

(22) Filed: Sep. 11, 2024

Related U.S. Application Data
(60) Provisional application No. 63/583,052, filed on Sep. 15, 2023.

(51) Int. Cl. C02F 1/44; C02F 101/14

(52) U.S. Cl. CPC C02F 1/442; C02F 2101/14; C02F 2201/002; C02F 2209/001; C02F 2209/40

(57) ABSTRACT

Described herein relates to a system and method of water treatment that integrates green sorption media with nanofiltration for the effective removal of perfluoroalkyl substances and/or polyfluoroalkyl substances (PFAS) from contaminated fluid. As such, the water filtration system may include a filtration chamber configured to pretreat the fluid prior to membrane filtration via the green sorption media. The green sorption media may comprise natural and/or recycled materials, including but not limited to sand, clay, perlite, and/or optionally zero-valent iron (ZVI), which pre-treats the fluid by adsorbing the perfluoroalkyl substances and/or polyfluoroalkyl substances. Additionally, the water treatment system may further comprise a crossflow nanofiltration chamber having at least one nanofiltration membrane configured to remove additional PFAS through size exclusion and/or electrostatic repulsion. The combined approach within the water treatment system may enhance the overall removal efficiency, particularly for the PFAS, while also reducing membrane fouling and/or extending operational life.

### CROSS-REFERENCE TO RELATED APPLICATIONS

This nonprovisional application claims the benefit of and priority to U.S. Provisional Patent Application No. 63/583,052 entitled “NANOFILTRATION SYSTEM AND METHOD INCLUDING PRETREATMENT WITH GREEN SORPTION MEDIA” filed Sep. 15, 2023 by the same inventors, all of which is incorporated herein by reference, in its entirety, for all purposes.

### BACKGROUND OF THE INVENTION

### 1. Field of the Invention

This invention relates, generally, to the removal of perfluoroalkyl and/or polyfluoroalkyl substances (hereinafter “PFAS”) during water treatment. More specifically, it relates to systems and methods of water treatment that include pretreatment of water with green sorption media before nanofiltration of the water to remove PFAS substances.

### 2. Brief Description of the Prior Art

Perfluoroalkyl substances and/or polyfluoroalkyl substances (hereinafter “PFAS”) are a large group of anthropogenic compounds that have widespread use in various industrial and commercial applications owing to their hydrophobic nature and chemical stability. The extensive use of PFAS inevitably leads to their ubiquity in the aquatic environment. Because of their unique properties, including bioaccumulation potential, recalcitrance, and toxicity, PFAS have been extensively studied by the scientific community (Buckley et al., 2023; Fenton et al., 2021; Haukås et al., 2007; Palma et al., 2021). Exposure to PFAS can result in several harmful health consequences, including liver toxicity, developmental and reproductive toxicity, carcinogenicity, and endocrine disruption (Fenton et al., 2021). The frequent detection of PFAS, classified as one of the contaminants of emerging concern (hereinafter “CECs”) by the US Environmental Protection Agency (hereinafter “EPA”) in drinking water sources, has raised serious public health concerns (Blake & Fenton, 2020). Nearly 200 million people across all 50 US states are regularly exposed to PFAS via drinking water with perfluorooctanoic acid (PFOA) and perfluorooctanesulfonic acid (hereinafter “PFOS”) concentrations at or above 1 ng·L⁻¹ (Andrews & Naidenko, 2020). The water bodies in many coastal regions are prone to pollution by PFAS and other CECs due to proximity to urban and industrial facilities, generating surface runoff and effluents that may be ultimately discharged into coastal water bodies.

In Florida, the Indian River Lagoon (hereinafter “IRL”) and the St. Lucie Estuary (hereinafter “SLE”) systems—highly diverse, unique ecosystems—are threatened by PFAS contamination (Griffin et al., 2022), raising considerable public concern. Lynch et al. (2019) reported an increasing trend in the concentration of perfluorododecanoate in female Indian River Lagoon dolphins (Lynch et al., 2019), which serve as sentinel species for coastal ecosystem pollution (Bossart, 2011), indicating PFAS exposures and risks to other species as well. Owing to the karst aquifers, Florida groundwaters contain high hardness and dissolved organic matter compared to those of many other states (USGS, 2005; Yang et al., 2017). The elevated concentrations of these constituents play critical roles in the remediation of CECs in water through various physicochemical processes (Sadmani et al., 2014). For instance, calcium and other divalent cations may interact with PFAS anions, retaining them in the aqueous phase, thereby governing their fate and transport in water matrices (Gagliano et al., 2020). Furthermore, high levels of ions and organic carbon may cause scaling and fouling of water treatment membranes and reduce their lifespan and also suppress the adsorption of contaminants like PFAS onto adsorption media (Suhalim et al., 2022).

Conventional water treatment processes are not specifically designed to remove PFAS from water due to their trace concentrations in water and resistance to degradation because of the strong C—F bond. Effective advanced PFAS treatment methods, including activated carbon filtration, reverse osmosis (hereinafter “RO”), biological treatment, UV irradiation, chlorine or ozone oxidation, and ion exchange have various limitations, including non-selectivity, frequent exhaustion, need for regeneration, high operational and maintenance cost, the formation of shorter-chain PFAS, undesired by-products, and so on (Gagliano et al., 2020). Hence, a more efficient and economical solution to removing PFAS from contaminated water sources is required. Membranes have demonstrated great promise in the selective and efficient removal of CECs (Sadmani et al., 2014; Toure & Sadmani, 2019). However, contaminant removal via NANOFILTRATION can be affected by various contaminant and membrane properties and water matrix characteristics, including the presence and composition of natural organic matter (hereinafter “NOM”), colloidal and suspended particles, and cations and anions. Therefore, nanofiltration membranes are susceptible to organic and inorganic fouling and scaling during long-term operation (Ritt et al., 2020). Among the fouling and scaling control strategies, feedwater pretreatment using activated carbon adsorption (Huang et al., 2019), ion exchange (Imbrogno et al., 2018), and low-pressure membrane processes, including microfiltration (Lee & Lee, 2006) and ultrafiltration (Yu et al., 2021), have proven effective. However, there are high costs associated with raw materials, media regeneration, and the disposal of spent media or operation and maintenance when applying such pretreatment technologies.

In addition, previous attempts have been directed toward the treatment of long-chain PFAS. While the predominant long-chain PFAS are being replaced by short-chain PFAS for industrial applications to reduce environmental and health impacts, the short-chain PFAS are as equally persistent as the long-chain ones. Unlike their long-chain counterparts, the short-chain PFAS are less likely to be adsorbed onto solid surfaces and, hence, occur mostly in aqueous phases. Therefore, these compounds have higher mobility in water, leading to increased aquatic life and human exposure (Alves et al., 2020). Furthermore, the short- and long-chain PFAS have been reported to not interact with adsorption media in the same manner, and, thus, they exhibit varying removal efficiencies (Inyang & Dickenson, 2017). Therefore, it is necessary to understand the differences in the mechanisms of adsorption and removal of short- and long-chain PFAS by green sorption media that are mixed with natural and recycled materials and the effects of the presence of other competing water constituents on adsorptive interactions.

Accordingly, what is needed is a system and method of cost-effective, sustainable, adaptable, and scalable water treatment that include pretreatment of water with green sorption media prior to nanofiltration of the water to remove PFAS substances. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. The long-standing but heretofore unfulfilled need for a water treatment system and method for removing per- or polyfluoroalkyl substances from fluid is now met by a new, useful, and nonobvious invention.

As such, an aspect of the present disclosure pertains to a water treatment system for removing per-fluoroalkyl substances and/or polyfluoroalkyl substances from a fluid. In an embodiment, the water treatment system may comprise the following: (a) a filtration chamber for pretreating the fluid, the filtration chamber including a green sorption media; and/or (b) a crossflow nanofiltration chamber fluidically coupled to the filtration chamber, the crossflow nanofiltration chamber comprising at least one nanofiltration membrane and/or centrifugal pump. In this embodiment, the filtration chamber may be in mechanical communication and/or fluidic communication with the crossflow nanofiltration chamber, such that subsequent to pretreating the fluid, the filtration chamber may transport the pretreated fluid to the crossflow nanofiltration chamber. In this manner, the crossflow chamber may be configured to receive pretreated fluid from the filtration chamber and/or filter the pretreated fluid through the at least one nanofiltration membrane, via the centrifugal pump.

In some embodiments, the green sorption media may comprise of a mixture of sand particles of about 85 vol %, clay particles of about 5 vol %, or both. In these other embodiments, the green sorption media may further comprise perlite particles of about 5 vol %. In this manner, the filtration media may also comprise a plurality of zero-valent iron (hereinafter “ZVI”) particles of at most 5 vol %. In addition, in these other embodiments, the plurality of ZVI particles are disposed about at least one portion of an outer surface of the green sorption media. As such, the green sorption media may exhibit a point of zero charge (hereinafter “PZC”) of about 5.2 to about 9.6. Furthermore, the green sorption media may be hydrophobic.

In some embodiments, the crossflow nanofiltration chamber may further include a feed tank. As such, the filtration chamber may be configured to receive the fluid from the feed tank and/or pretreat the fluid, via the green sorption media. In these other embodiments, the fluid may be filtered through the green sorption media, such that a first portion of perfluoroalkyl substances and/or polyfluoroalkyl substances may be adsorbed within at least one portion of a surface of the green sorption media.

In some embodiments, the water treatment system may further comprise a plurality of divalent cations disposed about at least one portion of the filtration chamber, and/or the crossflow nanofiltration chamber. In these other embodiments, at least one of the plurality of divalent cations may be disposed about at least one portion of a surface of the at least one nanofiltration membrane, such that at least one of a plurality of pores disposed on the surface of the at least one nanofiltration membrane may be shielded.

In some embodiments, the crossflow nanofiltration chamber may also have a plurality of flowmeters, such that the plurality of flowmeters may be configured to monitor the rate of water translation through the crossflow nanofiltration chamber to optimize filtration, via the at least one nanofiltration membrane.

Another aspect of the present disclosure pertains to a method of removing perfluoroalkyl substances and/or polyfluoroalkyl substances from a fluid. In an embodiment, the method may comprise the following steps: (a) mixing a green sorption media having sand particles of about 85 vol %, clay particles of about 5 vol %, and perlite particles of about 5 vol %; (b) disposing an amount of the green sorption media into a filtration chamber; (c) pretreating, via the green sorption media, an amount of fluid containing perfluoroalkyl substances and/or polyfluoroalkyl substances to remove a first portion of perfluoroalkyl substances and/or polyfluoroalkyl substances from the fluid, thereby generating a pretreated fluid; (d) receiving, via a crossflow nanofiltration chamber in mechanical communication and/or fluidic communication with the filtration chamber, the pretreated fluid; and/or (e) filtering, via at least one nanofiltration membrane of the crossflow nanofiltration chamber, the pretreated fluid to remove a second portion of perfluoroalkyl substances and/or polyfluoroalkyl substances from the pretreated fluid.

In some embodiments, the filtration media may further comprises zero-valent iron particles of at most 5 vol %. In addition, the green sorption media may also include silica disposed about at least one portion of an outer surface of the green sorption media. In these other embodiments, the green sorption media exhibits a point of zero charge (hereinafter “PZC”) of about 5.2 to about 9.6. In this manner, the green sorption media is hydrophobic.

In some embodiments, the method may further comprise the step of, disposing a plurality of divalent cations about at least one portion of the filtration chamber and/or the crossflow nanofiltration chamber. In this manner, in these other embodiments, the method may further comprise the step of, subsequent to disposing a plurality of divalent cations about at least one portion of the filtration chamber and/or the crossflow nanofiltration chamber, shielding, via at least one of the plurality of divalent cations, at least one of a plurality of pores on the surface of the at least one nanofiltration membrane.

An object of the invention may be to improve the removal of perfluoroalkyl and/or polyfluoroalkyl substances from fluid using a water treatment system with synergistic effect including pretreatment of the fluid with filtration media mixes, followed by nanofiltration. Another object of the invention is to remove some portion of long-chain PFAS, calcium ions, and total organic carbon (TOC) simultaneously up front via green sorption media pretreatment, followed by a membrane for nanofiltration to remove a majority of the rest of the long-chain and short-chain PFAS with reducing concerns of scaling and fouling.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the invention, reference should be made to the following detailed description, taken in connection with the accompanying drawings, in which:

FIG. 1 graphically depicts x-ray photoelectron spectroscopy (XPS) spectra for the filtration media clay-perlite and sand (CPS), specifically showing Si2p (Section A), O1s (Section B), C1s (Section C), and Al2p (Section D), with the x-axis corresponding to the binding energy (eV) of electrons from different orbitals, and the y-axis corresponding to the intensity, which determines the atomic composition of the media sample based on the amounts of each electron from the different orbitals present, according to an embodiment of the present disclosure.

FIG. 2 graphically depicts XPS spectra for the filtration media zero-valent iron and perlite-based green environmental media (hereinafter “ZIPGEM”), specifically showing Si2p (Section A), O1s (Section B), C1s (Section C), Al2p (Section D), and Fe2p (Section E) with the x-axis corresponding to the binding energy (eV) of electrons from different orbitals, according to an embodiment of the present disclosure.

FIG. 3 depicts a process flow diagram outlining a method of evaluating different water treatments, including a control (e.g., Process 1), a water treatment system including pretreatment with CPS (e.g., Process 2), and a water treatment system including pretreatment with ZIPGEM (e.g., Process 3), according to an embodiment of the present disclosure.

FIG. 4 depicts a filtration chamber for pretreating water using CPS and/or ZIPGEM, according to an embodiment of the present disclosure.

FIG. 5 depicts a process flow diagram outlining a nanofiltration crossflow system, according to an embodiment of the present disclosure.

FIG. 6 graphically depicts PFAS removal by different filtration media and filtration systems, including pretreatment with CPS and ZIPGEM (Section A), use of a nanofiltration membrane in combination with CPS or ZIPGEM pretreated waters (Section B), green sorption media-nanofiltration water treatment systems (Section C), and a control including nanofiltration without pretreatment (Section D), according to an embodiment of the present disclosure.

FIG. 7 depicts interactions between green sorption media and water components, as well as green sorption media and PFAS, resulting in PFAS removal, according to an embodiment of the present disclosure.

FIG. 8 depicts PFAS removal mechanism via nanofiltration, according to an embodiment of the present disclosure.

FIG. 9 graphically depicts nanofiltration membrane flex decline during filtration of CPS and ZIPGEM pretreated water (Section A), concentrations of Ca²⁺ (Section B), concentrations of total organic carbon (TOC) (Section C), and concentrations of dissolved organic carbon (DOC) (Section D), according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “of” is generally employed in its sense including “and/or” unless the context clearly dictates otherwise.

As used herein, the term “mechanical communication” refers to any coupling mechanism configured to transmit and/or exchange any force known in the art using any methods and/or device known in the art. Non-limiting examples of mechanical communication may include mechanical coupling, clamps, gear drives, gear shafts, drive shaft, universal joint, sleeve coupling, roller chain coupling, flange coupling, Oldham coupling, Split Muff coupling, and/or flange couplings. For ease of reference, the exemplary embodiment described herein refers to mechanical coupling, but this description should not be interpreted as exclusionary of other mechanical coupling mechanisms.

As used herein, the terms “fluid communication” and/or “fluidic communication” refer to any coupling mechanism known in the art configured to transmit and/or exchange any fluid known in the art using any methods and/or device known in the art. Non-limiting examples of fluid communication may include fluid coupling, tubing, tubing nipples, plumbing connectors, plumbing fittings, fluid clamps, channels, valves, pressure valve, and/or pressure coupling. For ease of reference, the exemplary embodiment described herein refers to tubing, channels, tubing nipples, and/or valves, but this description should not be interpreted as exclusionary of other fluid coupling mechanisms

As used herein, the term “adsorption” refers to the process by which molecules, ions, or particles adhere to the surface of a solid material. In the context of this invention, adsorption is a key mechanism by which the green sorption media may remove perfluoroalkyl and/or polyfluoroalkyl substances (PFAS) from water. The process involves physical or chemical interactions between the adsorbent and the adsorbate, where the PFAS molecules may be trapped on the surface of the green sorption media due to hydrophobic interactions and/or electrostatic attraction. Adsorption is distinct from absorption, where the substance penetrates into the bulk of the material.

As used herein, the term “binding energy” refers to the energy required to remove an electron from an atom, ion, and/or molecule, measured in electron volts (eV). It is a critical parameter in X-ray photoelectron spectroscopy (XPS), which is used in this invention to analyze the surface composition of the green sorption media. The binding energy values obtained from XPS spectra provide insight into the chemical states of elements present in the media, such as silicon, oxygen, carbon, and aluminum, which contribute to the media's ability to adsorb PFAS. Lower binding energy values indicate weaker interactions between electrons and the nucleus, while higher values suggest stronger binding, relevant in understanding the material's surface chemistry.

As used herein, the term “fouling” refers to the accumulation of unwanted materials on the surface of a filtration membrane, which can include but is not limited to organic matter, inorganic salts, microorganisms, and/or colloidal particles. Fouling is a critical issue because it leads to a decline in membrane performance, reducing permeate flux and increasing operational pressures, which in turn may elevate energy consumption and/or maintenance costs.

As used herein, the term “crossflow nanofiltration” refers to a filtration process where the feed solution may flow tangentially across the surface of at least one nanofiltration membrane, rather than directly through it. This design may reduce the buildup of a fouling layer on the membrane surface and/or may allow for the continuous removal of contaminants. The crossflow nanofiltration may be employed to filter pretreated water from the green sorption media, effectively removing remaining PFAS. The crossflow setup enhances the longevity and/or efficiency of the nanofiltration membrane by minimizing fouling, particularly important in systems dealing with high contaminant loads.

As used herein, the term “dissolved organic carbon (DOC)” refers to the fraction of organic carbon in water that passes through a filter, typically with a pore size of 0.45 micrometers. DOC may be a critical parameter in water treatment as it can contribute to fouling of filtration membranes and/or interfere with contaminant removal processes.

The term “electrostatic interaction” refers to the attractive and/or repulsive force between charged particles. PFAS molecules, which typically carry a negative charge in water, are attracted to positively charged sites on the GSM, particularly in media containing zero-valent iron (ZVI). This interaction facilitates the removal of short-chain PFAS, which are less hydrophobic and therefore rely more on electrostatic forces for adsorption.

The term “hydraulic conductivity” refers to the ability of a material to allow water to flow through it, typically measured in centimeters per second (cm/s). This property is particularly important for maintaining the flow rate and preventing clogging in the filtration system.

The term “hydrophobic interaction” refers to the tendency of nonpolar molecules or molecular regions to avoid contact with water, leading to their aggregation or association with other nonpolar substances. The hydrophobic tails of PFAS molecules may interact strongly with the nonpolar surfaces of the GSM components, facilitating their removal from water. This interaction may be particularly effective for the adsorption of long-chain PFAS, which are more hydrophobic than their short-chain counterparts.

The term “molecular weight cutoff (MWCO)” refers to the lowest molecular weight of a solute, 90% of which can be retained by a filtration membrane, typically measured in Daltons (Da). The MWCO may be a critical parameter in determining the selectivity and/or effectiveness of the membrane in removing contaminants, including PFAS, from water. The chosen MWCO may balance the need for removing large molecules while allowing smaller, essential ions to pass through.

The term “nanofiltration” refers to a membrane filtration process that removes contaminants from water based on size exclusion and electrostatic interactions. Nanofiltration membranes typically have a MWCO between about 200 and about 1000 Da, encompassing every value in between, making them effective for removing a wide range of organic molecules, divalent ions, and certain smaller contaminants.

The term “perlite” refers to a form of volcanic glass that, when heated, expands and becomes porous, making it useful as a lightweight, adsorptive material. The porous nature of perlite allows it to trap and hold contaminants, including PFAS, from water. The role of perlite in the green sorption media may be to enhance the overall adsorption capacity of the media, particularly for removing smaller, more mobile PFAS molecules that might otherwise pass through less porous materials.

The term “polypiperazine-amide” refers to a polymer material commonly used in the construction of nanofiltration membranes due to its favorable chemical resistance and mechanical properties. The polymer's structure includes functional groups that contribute to the membrane's selective permeability, particularly in rejecting PFAS molecules based on their size and charge. The choice of polypiperazine-amide may be critical for the membrane's ability to effectively remove contaminants while maintaining long-term operational performance.

The term “porosity” refers to the measure of void spaces in a material, expressed as a percentage of the total volume, which affects the material's ability to hold and transport fluids. A higher porosity indicates more available space within the media for water flow and contaminant capture, enhancing the media's overall effectiveness. The green sorption media may be designed with significant porosity to ensure efficient water treatment, balancing the need for high flow rates with the requirement for effective adsorption.

The term “retentate” refers to the portion of a feed solution that does not pass through a filtration membrane and is retained on the membrane's surface or within the feed stream. The retentate may typically comprise of the concentrated contaminants, including PFAS, which may be removed from the water during nanofiltration.

As used herein, the term “about” or “roughly” means approximately or nearly and in the context of a numerical value or range set forth means±15% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Water Treatment System and Methods Thereof

The present invention pertains to a system (hereinafter “water treatment system”) and methods thereof of water treatment that include pretreatment of water with green sorption media before nanofiltration of the water to remove PFAS substances. In an embodiment, the water treatment system may comprise a filtration chamber in mechanical communication and/or fluidic communication with a crossflow nanofiltration chamber, such that the filtration chamber may be configured to pretreat fluid prior to membrane filtration via the crossflow nanofiltration chamber. In this embodiment, the filtration media may include a mixture of sand particles of at least about 85 vol %, clay particles of about 5 vol %, and/or perlite particles of about 5 vol %. In addition, in an embodiment, the crossflow nanofiltration chamber may comprise a feed tank, a centrifugal pump, and/or a nanofiltration membrane, such that the crossflow nanofiltration chamber may be configured to receive pretreated fluid from the filtration chamber and/or may be configured to filter the pretreated fluid through the nanofiltration membrane via the feed tank and the centrifugal pump. Embodiments of the system and method of water treatment are described herein below.

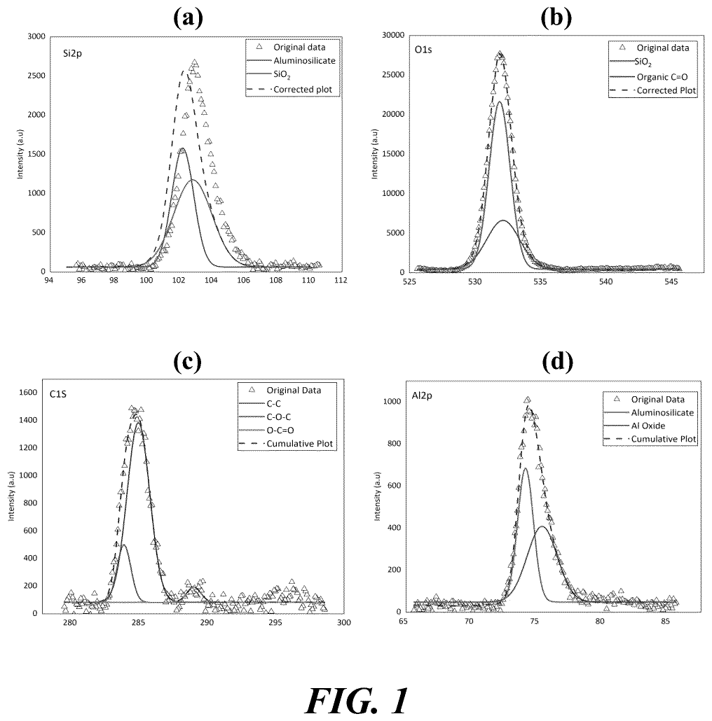

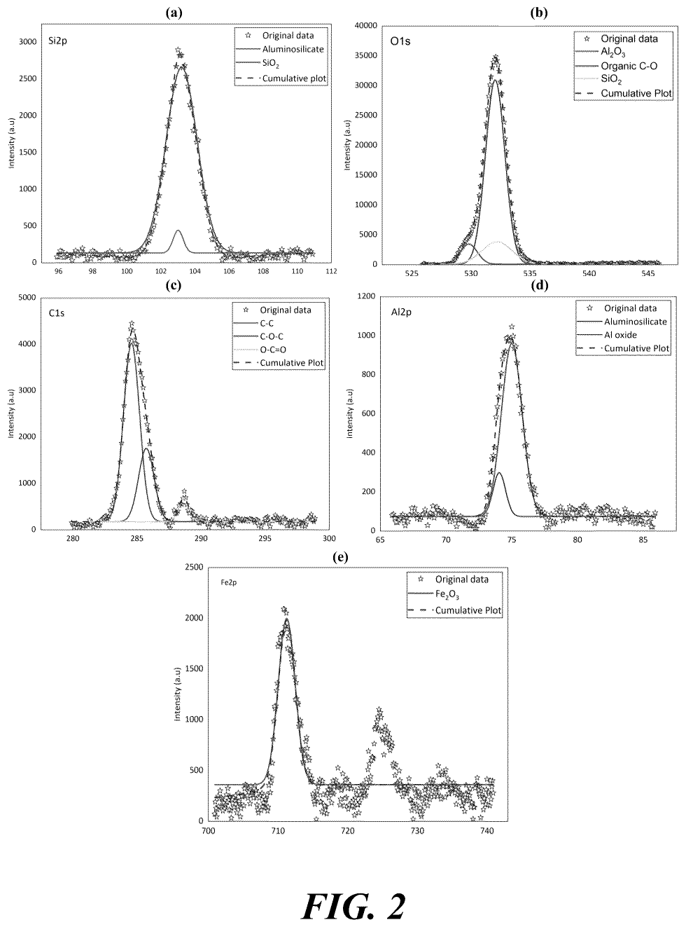

In an embodiment, the green sorption media (i.e., ZIPGEM) comprise a large surface area. In this embodiment, as shown in FIG. 1 and FIG. 2, the surface area of the green sorption media may comprise a range of about 1.08 m²·g⁻¹ to about 2.25 m²·g⁻¹, encompassing every value in between. Additionally, in this embodiment, the green sorption media may comprise a density having a range of about 2.61 g·cm⁻³ to about 2.80 g·cm⁻³, encompassing every value in between. Moreover, as shown in FIG. 1 and FIG. 2, the green sorption media may also comprise a porosity having a range of about 26% to about 29%, encompassing every value in between and/or a hydraulic conductivity having a range of about 1.7×10−4 cm·sec⁻¹ to about 2.8×10−4 cm·sec⁻¹, encompassing every value in between. In this embodiment, the green sorption media may be integrated within a water filtration system comprising at least one nanofiltration filter (e.g., NOM removal, and/or PFAS removal). The chemical characterization of these media mixes was further examined to better understand their morphology in relation to the PFAS removal mechanisms.

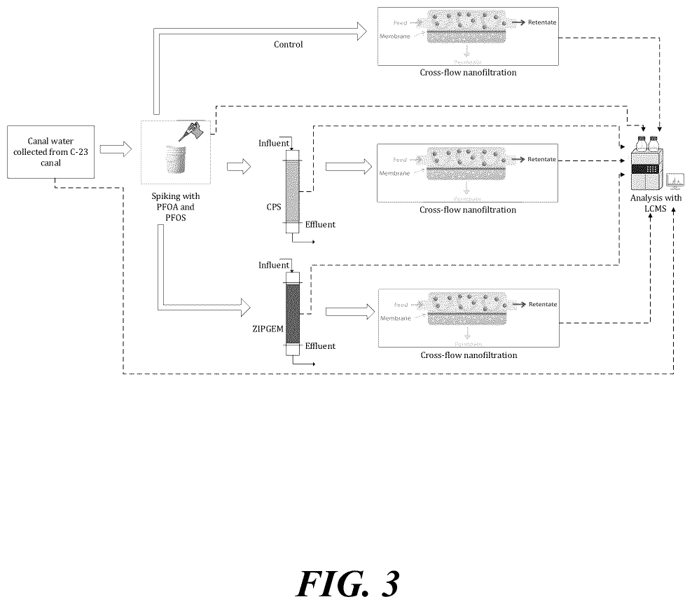

Additionally, as shown in FIG. 3, in an embodiment, in addition to the green sorption media, the water treatment system may further comprise at least one nanofiltration membrane (e.g., XN45). As such, in this embodiment, the at least one membrane may be cut into coupons of required sizes having an active surface area of about 42 cm², such that the at least one nanofiltration filter may be fit into a membrane cell (e.g., CF042).

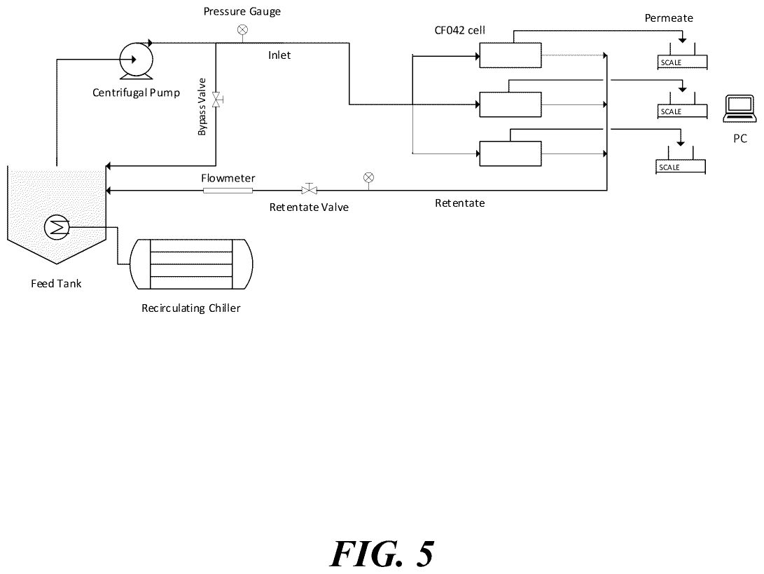

As shown in FIGS. 3-5, in an embodiment, the at least one nanofiltration membrane may comprise of a polypiperazine-amide polymer and/or the at least one nanofiltration member may be hydrophobic. In this manner, the at least one nanofiltration member may also comprise a contact angle having a range of about 55° to about 59°, encompassing every value in between. In addition, in this embodiment, the at least one nanofiltration membrane may have a molecular weight cutoff (hereinafter “MWCO”) of about 500 Daltons (hereinafter “Da”), such that the at least one nanofiltration membrane may remove a solute of molecular weight of about 500 Da with more than about 90% efficiency. As such, in this embodiment, the at least one nanofiltration membrane may also contribute a plurality of chemical moieties (e.g., carboxylic and/or amine groups) upon ionization in PFAS removal mechanisms in water.

In addition, in an embodiment, the water treatment system may further comprise a feed tank, a centrifugal pump, at least one pressure gauge communicatively coupled and/or fluidically coupled to the at least one nanofiltration membrane, at least one check valve, and/or a plurality of flowmeters. In this manner, a recirculating chiller may also be used for regulating the temperature of the water treatment system at about 20° C. In this embodiment, three high-precision balances may also be used to measure the weight of the collected permeate and/or to calculate the flowrates. As such, the water treatment system may further comprise a computing device having at least one processor, such that the at least one processor may be communicatively coupled to the at least one pressure gauge, the at least one check valve, and/or the plurality of flowmeters for data acquisition.

Additionally, as shown in FIGS. 3-5, in an embodiment, before each water filtration, at least one of the membrane cells and/or associated tubing of the water treatment system may be cleaned by running deionized fluid (e.g., water) as feed without placing any membrane coupons inside the cells. Next, the at least one nanofiltration membrane (e.g., membrane coupons) may be mounted into at least one of the membrane cells firmly and/or compacted at a predetermined pressure (e.g., about 100 psi) for a predetermined period of time (e.g., at least about 4 hours) using the deionized fluid. Furthermore, in this embodiment, the effluents from the pretreatment media may be taken as feedwater for each filtration by the water treatment system. Accordingly, the predetermined pressure within at least one of the membrane cells may be altered over time as feed concentration increased during the permeate collection. In this manner, both the retentate and permeate may be recycled by the water treatment system, except the time of permeate collection.

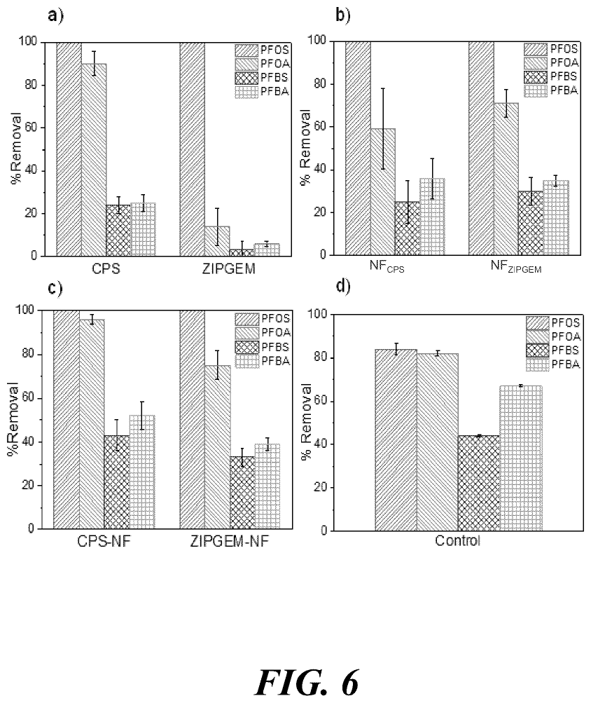

As shown in FIG. 6 (Section A-D), in an embodiment, the green sorption media and/or the at least one nanofiltration media of the water treatment system may be configured to remove long-chain PFAS by both at a greater efficiency than that for short-chain PFAS. Accordingly, in this embodiment, the green sorption media may have an average removal percentage of PFOS comprising a range of about 95% to about 100%, encompassing every value in between; an average removal percentage of PFOA comprising a range of about 14% to about 90%, encompassing every value in between; an average removal percentage of PFBS comprising a range of about 3.3% to about 24%, encompassing every value in between; and/or an average removal percentage of PFBA comprising a range of about 6% to about 25%, encompassing every value in between.

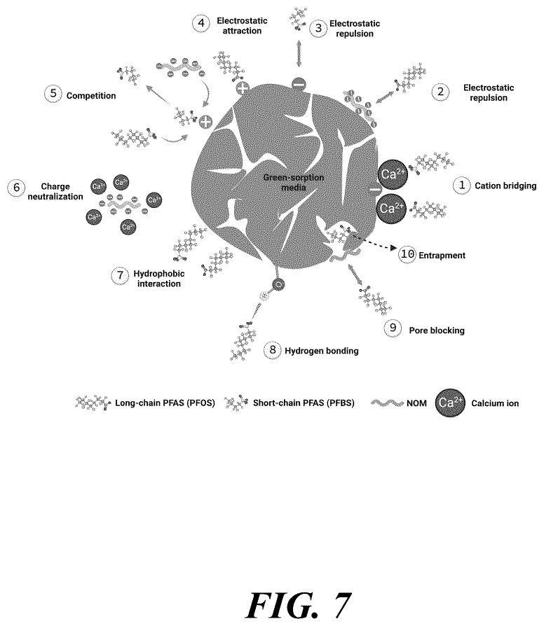

As known in the art, long-chain PFAS like PFOS and PFOA can form micelles that can lead to higher removal by the membrane. As such, as shown in FIG. 7, in an embodiment, the water treatment system may be configured to remove NOM and/or background cations like Ca²⁺, which may act as positive catalysts for the removal of PFAS using the at least one nanofiltration membrane. In this manner, if NOM and/or divalent cations are removed by the green sorption media, there may be less “cation bridging”, as shown in FIG. 7. Additionally, in an embodiment, the at least one nanofiltration membrane may comprise pore shielding by divalent cations and/or the at least one nanofiltration membrane may shield and/or cover at least one portion of a plurality of pores disposed about the at least one nanofiltration membrane by foulants, increasing PFAS removal. Therefore, the removal of NOM and cations from the water matrix by green sorption media-based pretreatment leads to lower removal efficiency of PFAS by subsequent membrane treatment.

Moreover, in an embodiment, the green sorption media may be hydrophobic, as PFAS compounds are predominantly hydrophobic in nature, especially the long-chain PFOS and PFOA, may be removed through hydrophobic interaction by the green sorption media. Additionally, the green sorption media may comprise electrostatic behavior, as the short-chain PFAS such as PFBS and PFBA may be much less hydrophobic and/or have higher solubility in water. Accordingly, their removal is governed by electrostatic interaction. In this manner, in this embodiment, the green sorption media of the water treatment system may contain metals embedded on the surface of the silica. In addition, the green sorption media may exhibit a point of zero charge (hereinafter “PZC”) having a range of about 5.2 to about 9.6, encompassing every value in between. Therefore, upon contact with the water, the surface of the green sorption media may become negatively charged or positively charged, based on the pH of the water and/or environmental water source. In this manner, the zero valent ion (hereinafter “ZVI”) in the green sorption media of the water treatment system may facilitate PFAS removal through not only adsorption but also reductive degradation and/or complexation. Furthermore, the inclusion of ZVI may lead to a higher point of zero charge of the green sorption media, optimizing PFAS removal performance.

PFAS compounds remain as anions in the water matrix at an environmentally relevant pH (e.g., pH=7). As such, in an embodiment, the green sorption media may hydrophobically with the PFAS compounds. Both the hydrophobic and/or the electrostatic interactions contribute to the removal of long-chain PFAS, such as PFOS and PFOA. However, hydrophobic interactions may be less influential in the case of PFBA or PFBS due to their short hydrophobic tails. In this embodiment, initially, both PFOS and PFOA compete for the adsorption sites of the green sorption media of the water treatment system through hydrophobic and/or electrostatic interaction. Once an adsorption site is occupied by a PFOS molecule, PFOA cannot evict that PFOS molecule because it is attached by a stronger hydrophobic interaction. Moreover, PFOS may replace PFOA and/or may also be adsorbed onto the media in the case of multilayer adsorption. Therefore, in this embodiment, the competition for adsorption sites of the green sorption media may increase with time, and/or the PFOA tends to desorb from its monolayer. When all the adsorption sites of the green sorption media may be occupied by PFOS and/or the background anions (e.g., NOM, HCO₃⁻, SO₄²⁻, etc.), the green sorption media may become shielded by negatively charged entities.

PFOA or any shorter-chain PFAS (e.g., PFBA, PFBS) not only face competition for adsorption sites but also are less likely to be removed because of electrostatic repulsion by both media. As such, in an embodiment, the water treatment system may further comprise a plurality of divalent cations disposed about the green sorption media and/or the at least one nanofiltration membrane, as the plurality of divalent cations act as a positive catalyst. In this manner, divalent cations (e.g., Ca²⁺) neutralize the negative charge of NOM in bulk water, which otherwise would take the place of PFAS in adsorption media. Moreover, in this embodiment, the plurality of divalent cations may bind with anionic PFAS and/or may help them adsorb on the surface of the green sorption media. Other mechanisms, as shown in FIG. 7, such as entrapment and/or hydrogen bonding, may also contribute to the PFAS adsorption process.

In an embodiment, the dominant PFAS removal mechanism by the at least one nanofiltration membranes may be size exclusion. As such, the at least one nanofiltration membrane of the water treatment system may be pretreated with the green sorption media—rather than only the sieving mechanism. Furthermore, in this embodiment, the at least one nanofiltration membrane may comprise a polyamide network in its structure containing carboxylic acid functional groups (R—COOH/R—COO⁻). Because anionic PFAS with small pKₐ values remain in deprotonated form at pH 7, electrostatic repulsion may also comprise an important role in the PFAS removal by the at least one nanofiltration membrane. In this manner, the charge density on the surface of the at least one nanofiltration membrane may depend on a variety of factors. Non-limiting examples of the variety of factors may include pH and/or the ionic strength of bulk water. Accordingly, the higher charge density exerts higher electrostatic repulsion, resulting in higher removal of PFAS.

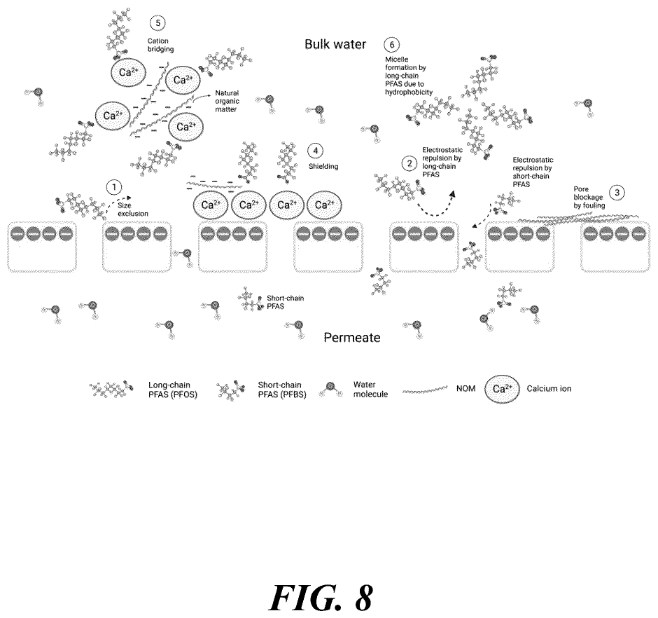

In an embodiment, although size exclusion is the dominant removal mechanism for long-chain PFAS, the Donnan exclusion mechanism may predominate for the at least one nanofiltration membrane of the water treatment system in the case of the short-chain PFAS. Accordingly, as shown in FIG. 8, in this embodiment, the plurality of divalent cations in the water matrix of the water treatment system may facilitate PFAS removal by shielding at least one of the plurality of pores disposed about the surface of the at least one nanofiltration membrane and/or via cation-bridging. The indigenous NOM in the bulk water may bind with PFAS by cation-bridging, consequently increasing PFAS removal by the at least one nanofiltration membrane. Unlike the long-chain PFAS that may be removed predominantly by the size exclusion mechanism because their molecular size is close to the MWCO of the membrane, the removal of short-chain PFAS may be dependent on electrostatic interaction because the short-chain PFAS tend to pass through the membrane pores due to their low molecular size. As such, in this embodiment, the electrostatic interaction of the at least one nanofiltration membrane may facilitate the formation of cation bridging between the plurality of divalent cations and their functional groups, which may thwart their diffusion through at least one of the plurality of pores disposed about the surface of the at least one nanofiltration membrane. Moreover, in this embodiment, the plurality of divalent cations may also form complex chemicals between PFAS and NOM through cation bridging between their functional groups. Therefore, short-chain PFAS may be removed via the size exclusion mechanism when they are bonded with NOM.

Furthermore, the plurality of divalent cations within the water matrix of the water treatment system may form cross-linking bonds between carboxylic groups of organic matter and that of membranes. Additionally, a greater concentration of PFBA in the influent may lead to a more complex formation with the plurality of divalent cations and/or NOM, as well as cross-linking, which in turn can lead to higher removal compared to PFBS.

As disclosed above, the integration of the green sorption media as pretreatment within the water treatment system may improve the overall removal efficiency of long-chain PFAS. In this manner, in an embodiment, the green sorption media may mix perform poorly in removing the short-chain PFAS. As such, in this embodiment the green sorption media pretreatment may remove the NOM and/or at least one of the plurality of divalent cations, which do not have a major effect on long-chain PFAS removal because they can be removed through size exclusion. However, the green sorption media pretreatment may significantly affect the removal of short-chain PFAS. Unlike long-chain PFAS, the short-chain PFAS are soluble and/or tend to remain in bulk water with cations and NOM. Therefore, removing NOM and cations causes reduced removal of short-chain PFAS. Moreover, the removal of anions and cations by the pretreatment media reduces the ionic strength of the water, leading to reduced charge density of the polyamide membrane and consequently reducing electrostatic repulsion between the short-chain PFAS and the membrane surface. As a result, the short-chain PFAS may easily pass through the membrane pores.

This finding indicates that the influent concentration of PFAS directly affects the removal efficiency of PFAS via nanofiltration. The significant removal of PFAS by green sorption media pretreatment may lead to reduced removal by the nanofiltration unit compared to that by nanofiltration without green sorption media pretreatment was revealed. However, when PFAS concentrations in the pretreatment media effluent are high, their removal efficiency by only the membrane increases significantly. Therefore, it may be concluded that PFAS removal efficiency by the at least one nanofiltration membrane of the water system may correlate to the influent (e.g., raw water) concentration. However, in this embodiment, when the green sorption media pretreatment of the water treatment system may be integrated with the at least one nanofiltration membrane as a practicable comprehensive water treatment scheme, the overall short-chain PFAS removal efficiency becomes significantly higher. Therefore, for the removal of short-chain PFAS, in this embodiment, the water treatment system comprising the green sorption media pretreatment, in addition to the at least one nanofiltration membrane, may always render higher removal efficiency compared to when the media and/or the membrane are applied individually.

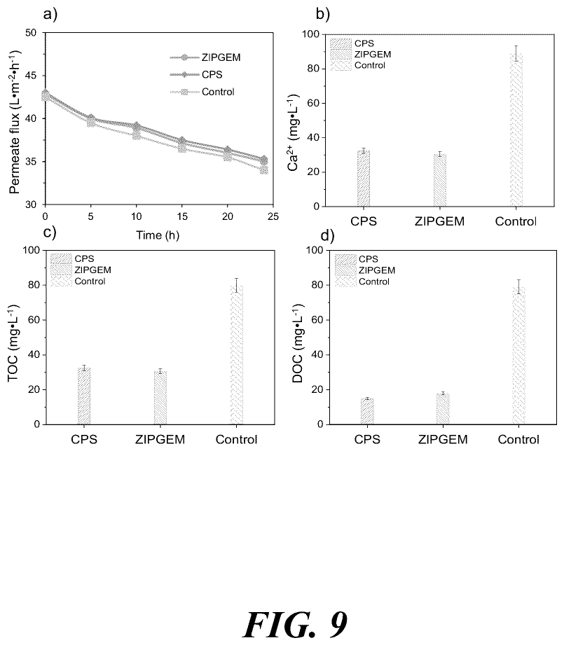

In addition, in an embodiment, the green sorption media of the water treatment system may serve as a cost-effective and sustainable means of reducing the fouling of the nanofiltration membrane. As shown in FIG. 9 (Sections A-D), in this embodiment, when the canal water was pretreated with the green sorption media, the at least one nanofiltration membrane permeate may be higher and/or the decline in permeate flux may be less compared to filtering the canal water without pretreatment. However, it is not significantly greater than that of treated water. As shown in FIG. 9 (Sections B-D), the green sorption media of the water treatment system may significantly reduce the concentrations of Ca²⁺, TOC, and/or DOC from the source water (e.g., environmental water), which has great potential to reduce membrane fouling.

Accordingly, in an embodiment, the water treatment system comprising the green sorption media pretreatment in tandem with the at least one nanofiltration membrane exhibit significantly higher removal of the long-chain PFAS (PFOS and/or PFOA) and/or short-chain PFAS (PFBA and/or PFBS). In this manner, the dominant mechanism of removal of PFOS (i.e., more hydrophobic compared to the rest of the PFAS) by the green sorption media pretreatment may comprise a hydrophobic interaction, whereas that of PFOA and/or the short-chain PFAS may be electrostatic interaction between those PFAS and the green sorption media. In addition, the water treatment system may exhibit significantly efficient removal of the long-chain PFAS. As such, the high efficiency of the green sorption media in removing the long-chain PFAS, in addition to NOM and/or the plurality of divalent cations (e.g., Ca²⁺) (which serve as positive catalysts in PFAS removal), may lead to lower removal efficiency of the at least one nanofiltration membrane in the water treatment system. However, this may be attributed to the reduction in concentrations of NOM and/or the plurality of divalent cations, and/or that of PFOS and/or PFOA molecules by the green sorption media pretreatment of the water treatment system, possibly leading to less calcium bridging and/or less micelle/complex formation by PFOS/A in bulk water, respectively. In this manner, the integration of the green sorption media pretreatment with the at least one nanofiltration membrane within the water treatment system may result in significantly enhanced PFAS removal efficiency by the water treatment system. Hence, when the green sorption media pretreatment fails to remove PFAS effectively (e.g., short-chain PFAS, upon media exhaustion), the at least one nanofiltration membrane may impart a significant role in the overall removal efficiency.

In an embodiment, the green sorption media pretreatment of the water treatment system may not only offer PFAS removal from source waters but the pretreatment may also serve as a cost-effective and/or sustainable means of reducing the at least one nanofiltration membrane fouling/scaling by removing NOM and/or at least one of the plurality of divalent cations from water. Therefore, water treatment system comprising both the green sorption media pretreatment and the at least one nanofiltration membrane may provide great potential for removing long- and/or short-chain PFAS from various water matrices.

Furthermore, in an embodiment, the green sorption media recipe may be modified to fine-tune the selectivity for short-chain PFAS while maintaining the at least one nanofiltration membrane fouling mitigation potential. Besides, selecting the at least one nanofiltration membrane comprising a high negative charge may facilitate higher removal of short-chain PFAS. Moreover, running the crossflow nanofiltration, via the at least one nanofiltration membrane, at a higher crossflow velocity may also mitigate the concentration polarization effect, consequently limiting any diffusion of short-chain PFAS through the membrane matrix.

The following examples are provided for the purpose of exemplification and are not intended to be limiting.

### EXAMPLES

### Example #1

### The Effect of Green Sorption Media Pretreatment on Nanofiltration During Water Treatment for Long- and Short-Chain Per- and Polyfluoroalkyl Substances (Hereinafter “PFAS”) Removal

### Experimental Methods

Water samples were collected from the C-23 canal, which is close to the St. Lucie River Basin in Florida. The C-23 canal was selected because it is connected to the St Lucie Estuary, which is a major tributary of the IRL. The IRL is an ecologically sensitive estuarine area and is of great importance for biodiversity because it is home to more than 3,000 species of plants and animals (US Army Corps of Engineers, 2023). Therefore, PFAS contamination of canal water could eventually affect the sensitive ecosystem of the IRL.

The water samples were collected from the same site of the C-23 canal during both the dry and wet seasons. However, only wet season water samples were used in the experiment. The water samples were analyzed for both long-chain (PFOA and PFOS) and short-chain (Perfluorobutanoic acid [PFBA] and Perfluorobutanesulfonic acid [PFBS]) PFAS following the modified EPA 537.1 method (Shoemaker & Tettenhorst, 2020). Through this method, an aliquot of a 250 mL water sample containing analytes and internal standards is extracted via solid phase extraction. The extracted analytes and internal standards are then eluted with methanol and ammonium hydroxide in methanol solvent. Then the eluted samples are dried with nitrogen and reconstituted to 1 mL volume with a buffer solution. The samples are then injected into a C18 liquid chromatography column, and the PFAS compounds are separated by a gradient of pure methanol and 20 mM ammonium acetate. Finally, the eluted compounds are detected, and their concentrations are measured via tandem mass spectrometry. The method detection limits (MDLs) for PFBA, PFBS, PFOA, and PFOS were 0.5 ng·L⁻¹, 2 ng·L⁻¹, 0.5 ng·L⁻¹, and 1 ng·L⁻¹, respectively. The concentration of calcium ion (Ca²⁺) was analyzed at Eurofins Flowers's Chemical Laboratories (Altamonte Springs, Florida) following EPA method 6010D using inductively coupled plasma optical emission spectroscopy (MDL=0.096 mg·L⁻¹). Total organic carbon (TOC) and dissolved organic carbon (DOC) were measured using a TOC analyzer following EPA method 415.3.

Two long-chain (i.e., PFOA and PFOS) and two short-chain (i.e., PFBA and PFBS) PFAS were selected for this experiment. Although PFOA and PFOS are the two most predominant and frequently detected and investigated PFAS, the toxicological effects of short-chain PFAS have been underestimated (Liu et al., 2022). Therefore, it is imperative to target both the long- and short-chain PFAS for remediation. TABLE 1 lists some physicochemical properties of the selected PFAS.

TABLE 1

| | | | | Molecular | | |
|---|---|---|---|---|---|---|
| | | | Chemical | Weight | | |
| | PFAS | CAS# | Formula | (g · mol⁻¹) | pKₐ | Log D^{a} |
| Short-chain | Perfluorobutanoic acid (PFBA) | 375-22-4 | C₃F₇COOH | 214 | 0.40 | −1.22 |
| | Perfluorobutanesulfonic acid (PFBS) | 375-73-5 | C₄F₉SO₃H | 300 | 0.14 | 0.25 |
| Long-chain | Perfluorooctanoic acid (PFOA) | 335-67-1 | C₇F₁₅COOH | 414 | −0.20 | 1.58 |
| | Perfluorooctanesulfonic acid (PFOS) | 1763-23-1 | C₈F₁₇SO₃H | 500 | 0.14 | 3.05 |

^{a}Log D: Octanol-water partition coefficient at pH 7 accounted for acid dissociation reactions determined using MarvinSketch (2023).

TABLE 2 presents the compositions of the two green sorption media (CPS and ZIPGEM). The physical characterization of these media reveals they have a large surface area (CPS: 1.08 m²·g⁻¹; ZIPGEM: 2.25 m²·g⁻¹) and high density (CPS: 2.61 g·cm⁻³; ZIPGEM: 2.80 g·cm⁻³). Moreover, the two media have significant porosity (CPS: 26%; ZIPGEM: 29%) and hydraulic conductivity (CPS: 1.7×10−4 cm·sec⁻¹; ZIPGEM: 2.8×10−4 cm·sec⁻¹), making them suitable for large-scale filtration applications (e.g., NOM removal; Ordonez et al., 2022). The chemical characterization of these media mixes was further examined to better understand their morphology in relation to the PFAS removal mechanisms. TABLE 2 also shows the X-ray fluorescence spectrophotometer (XRF) data for both media. The chemical composition can be further validated via X-ray photoelectron spectroscopy (XPS) analysis. As shown in FIGS. 1-2, the compounds likely to provide adsorption sites for PFAS include SiO₂, Al₂SiO₅, and Al₂O₃ for CPS and SiO₂, Al₂SiO₅, Al₂O₃, and Fe₂O₃ for ZIPGEM.

TABLE 2

| | | XRF Analysis of Chemical | | | | | |
|---|---|---|---|---|---|---|---|
| | Media Matrix and Composition^{a} | Composition (%)^{a} | | | | | |
| Media | (% by volume) | Al | Si | P | K | Ca | Fe |
| CPS | 92% sand, 5% clay, and 3% perlite | 9.8 | 84.6 | 1.8 | 2.4 | 1.0 | 0.5 |
| ZIPGEM | 85% sand, 5% clay, 5% ZVI*, and 5% | 8.4 | 70.3 | 1.9 | 2.8 | 1.0 | 12.1 |
| | perlite | | | | | | |

^{a}Source: Ordonez et al., 2022.
*ZVI: zero valent iron

A commercially available nanofiltration membrane (membrane ID: XN45) was used for the crossflow nanofiltration experiment. The membranes were acquired as flat sheets and cut into coupons of required sizes (active surface area of 42 cm²) to fit into a membrane cell (CF042). TABLE 3 presents the membrane characteristics.

TABLE 3

| Membrane ID | XN45 |
|---|---|
| Membrane Type | Nanofiltration |
| Manufacturer | TriSep |
| Polymer | Polypiperazine-amide |
| MWCO (Da) | 500 |
| Contact angle (degree) | 57 ± 1^{a} |
| Zeta potential at pH 5.5 (mV) | −25^{a} |
| Isoelectric point (IEP) | 4^{a} |
| Rejection (%) | 95% MgSO₄ |
| Flux (GFD)/psi | 35/110 |
| pH range | 2-11 |

^{a}Source: Hallé et al., 2023.

The membrane is made of polypiperazine-amide polymer and is hydrophobic with a contact angle of 57±1°. It has a molecular weight cutoff (MWCO) of 500 Daltons (Da), meaning it can remove a solute of molecular weight of 500 Da with more than 90% efficiency. Although an RO or tighter nanofiltration membrane (MWCO<300 Da) is likely to remove both long- and short-chain PFAS efficiently, the purpose of selecting a rather loose nanofiltration membrane was to facilitate the investigation of the effect of PFAS interactions with green sorption media pretreated water constituents on membrane removal rather than the sieving mechanism only. The polypiperazine amide-based membrane also provided a scope to explore the contribution of its chemical moieties (carboxylic and amine groups) upon ionization in PFAS removal mechanisms in water.

Water samples collected from the C-23 canal were first fortified with PFOS and PFOA and then used as influents to the pretreatment column containing one of the two green sorption media. Note the water samples were not fortified with PFBA and PFBS. The green sorption media effluent served as the feedwater for the nanofiltration unit of the proposed water treatment system. The nanofiltration membrane unit without any green sorption media-based pretreatment served as the “control.” The integration of a green sorption media (CPS or ZIPGEM) with crossflow nanofiltration is herein referred to as a water treatment system, denoted as CPS-nanofiltration or ZIPGEM-nanofiltration. The CPS and ZIPGEM column influents and effluents and nanofiltration permeates were analyzed for both long-chain (PFOS and PFOA) and short-chain (PFBS and PFBA) PFAS. FIG. 3 presents the green sorption media-nanofiltration hybrid treatment scheme.

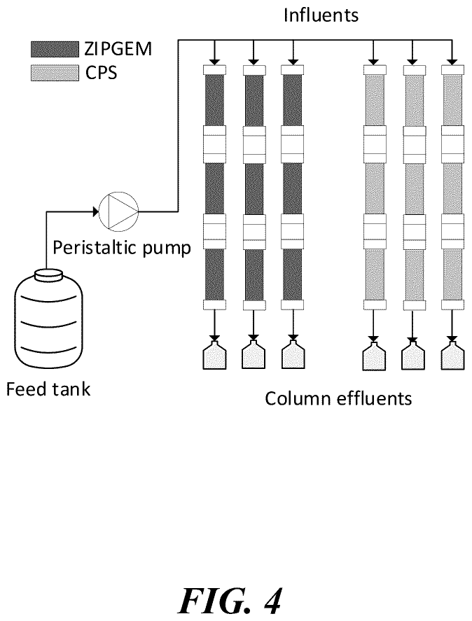

C-23 canal water was stored in a walk-in refrigerator at −17.8° C. after collection. For the pretreatment experiment, a total of 60 L of water was used as influents to the CPS and ZIPGEM columns. Although the raw water was spiked with 70 ng·L⁻¹ of PFOA and PFOS each, the short-chain PFAS (PFBA, PFBS) were at their indigenous concentrations. A peristaltic pump was used to deliver the water to the columns at a constant flowrate of 14 ml·min⁻¹. Three columns (triplicate) with 3 ft length and 4-inch diameter containing 2,600 ml of media were set up for each media, and all samples were analyzed in triplicate (FIG. 4). The fixed-bed column experiments were run for more than 48 h, and effluents were taken at different time intervals to be used as feedwaters for the nanofiltration treatment that followed. The column effluents from CPS at 9 h were used as feedwaters for the nanofiltration experiments because the breakpoint for CPS was observed at around 9 h, whereas the column effluents from ZIPGEM were collected between 9- and 30-h column runtimes, with the breakpoint occurring at around 12 h. At least 5 L of column effluent were collected to be used as the nanofiltration feed, and the stated effluent at 9 h for CPS was collected from 0 h until 9 h, whereas effluent at 30 h for ZIPGEM was collected from 9 h until 30 h. The collected effluents from the column study were stored in a refrigerator until they were used for the nanofiltration experiment. FIG. 4 illustrates the experimental setup for the pretreatment CPS and ZIPGEM process.

A bench-scale crossflow filtration setup was used in these experimental methods. The experimental setup consisted of a feed tank, a centrifugal pump, three CF042 membrane cells connected to pressure gauges, check valves, and flowmeters. A recirculating chiller was used for regulating the temperature at 20° C. Three high-precision balances were used to measure the weight of the collected permeate and to calculate the flowrates. The scales were connected to a computer for data acquisition.

Before each experimental run, the membrane cells and tubing were cleaned by running DI water as feed without placing any membrane coupons inside the cells. Then the membrane coupons were mounted into the cells firmly and compacted at 100 psi for at least 4 h using DI water. After that, 5 L of the effluents from the pretreatment media (i.e., the C-23 water samples that were run through the CPS and ZIPGEM) were taken as feedwater for each nanofiltration filtration experiment. The experiments were run for 24 h before collecting permeates and feed samples for analysis. The experiments were conducted at a constant flowrate of 1.0 L·min⁻¹, with a corresponding cross flow velocity of 0.18 m·s⁻¹. The transmembrane pressure was initially set to 110 psi at the beginning of the permeate collection by regulating inlet and retentate valves. However, the pressure changed over time as feed concentration increased during the permeate collection. The experiment was run in total recirculation mode, whereby both the retentate and permeate were recycled, except the time of permeate collection.

A one-way analysis of variance (ANOVA; Eq. 1-4) was used to determine whether there were any statistically significant differences in the removal efficiencies between the long- and short-chain PFAS when using the tested combinations of the water treatment systems and the control. TABLE 4 lists the null hypotheses (H₀) and the alternative hypotheses (Hₐ; Eq. 1 and Eq. 2). Any null hypothesis was rejected when the p-value was less than α (0.05) at a confidence interval of 95%. Additionally, a post hoc Tukey test was performed for pairwise comparison of the cases listed in TABLE 4. The data used in the ANOVA test was assumed to be normally distributed.

$${H}_{0} : {μ}_{1} = … = {μ}_{k} \qquad ( 1 )$$

Hₐ: means are not all equal or at least one mean is different. (2)

$$SDB = {\sum }_{i}^{k} {{n}_{i} ( {X}_{i} - X )}^{2} \qquad ( 3 )$$

$$SSW = {\sum }_{i}^{k} ( {n}_{i} - 1 ) {{S}_{i}}^{2} \qquad ( 4 )$$

where μ is the mean of each independent group, SSB is the sum of squares between groups, and SSW is the sum of squares within groups.

$$F ( = \frac{MSB}{MSW} )$$

is the ANOVA coefficient,

$$MSB ( = \frac{SSB}{k - 1} )$$

is the mean sum of squares due to treatment,

$$MSW ( = \frac{SSW}{n - k} )$$

is the mean sum of squares due to error, k is the number of groups, n is the sample size, Xᵢ is the average of group i, and X is the overall group average. TABLE 4 lists the proposed hypotheses.

TABLE 4

| Aspects | | Hₒ | Hₐ |
|---|---|---|---|
| 1 | Removal efficiencies of long- and short-chain PFAS | − | + |
| | by both green sorption media | | |
| 2 | Removal efficiencies of PFSAs and PFCAs by both | − | + |
| | green sorption media | | |
| 3 | Removal efficiency via any of the water treatment | − | + |
| | systems (CPS-nanofiltration and ZIPGEM- | | |
| | nanofiltration) and the control. | | |
| 4 | Removal efficiencies of the membrane in the water | − | + |
| | treatment system and that of the control. | | |
| 5 | Concentrations of TOC, DOC, and Ca²⁺ in the raw canal | − | + |
| | water and the green sorption media-pretreated water. | | |

*Hₒ = null hypothesis; Hₐ = alternative hypothesis; ‘−’ = no significant difference exists; ‘+’ = a significant difference exists.

### Results

The average removal efficiencies of each media pretreatment were calculated based on PFAS concentrations in the influents and effluents of triplicate columns, as disclosed in TABLE 5. The concentration of membrane permeates, as shown in TABLE 5, measured in triplicates (i.e., from three membrane cells), were averaged to calculate membrane removal efficiency (Eq. 5). The overall efficiency of the hybrid treatment was calculated by comparing the average concentrations of PFAS in the influents of the green sorption media pretreatment columns and the nanofiltration permeates, as disclosed in TABLE 6.

$$\% Removal = ( \frac{{C}_{0} - {C}_{e}}{{C}_{0}} ) \times 100 \% \qquad ( 5 )$$

where C₀ is the concentration of PFAS in the column influent or nanofiltration feed in ng·L⁻¹, and where Cₑ is the concentration of PFAS in the column effluent or nanofiltration permeate in ng·L⁻¹. TABLE 7 summarizes the key findings of the green sorption media-based pretreatment and green sorption media-nanofiltration treatment, and these are explained in the subsequent subsection through an in-depth discussion and statistical analysis. It should be noted that PFOS concentration was slightly higher in the membrane permeates compared to the effluent of green sorption media pretreatment media, as disclosed in TABLE 5. The slight increase in PFOS concentration could be attributed to the filtration experimental setup that operated in a total recirculation mode. However, most of the differences were very close to the MDL for PFOS (1 ng·L⁻¹), which was already undetected in the green sorption media effluent

TABLE 5

| | CPS-nanofiltration @ 9 h (ng · L⁻¹) | | | | | | | | | ZIPGEM-nanofiltration @30 h (ng · L⁻¹) | | |
|---|---|---|---|---|---|---|---|---|---|---|---|---|
| | Col 1 | | | Col 2 | | | Col 3 | | | Col 1 | | |
| | Inf | Effl. | MP | Inf | Effl. | MP | Inf | Effl. | MP | Inf | Effl. | MP |
| PFBA | 7.6 | 6.0 | 3.20 | 7.6 | 5.8 | 4.17 | 7.6 | 5.4 | 3.60 | 7.4 | 7.0 | 4.43 |
| PFBS | 5.5 | 4.4 | 3.27 | 5.5 | 4.0 | 3.40 | 5.5 | 4.1 | 2.67 | 6.5 | 6.1 | 4.67 |
| PFOA | 92 | 3.8 | 2.27 | 92 | 14 | 5.83 | 92 | 11 | 2.43 | 79 | 64 | 21.67 |
| PFOS | 71 | 0.0 | 2.0 | 71 | 0.0 | 1.90 | 71 | 0.0 | 0.74 | 70 | 0.0 | 1.70 |

| | ZIPGEM-nanofiltration @30 h (ng · L⁻¹) | | | | | | | |
|---|---|---|---|---|---|---|---|---|
| | Col 2 | | | Col 3 | | | Control(ng · L⁻¹) | |
| | Inf | Effl. | MP | Inf | Effl. | MP | Inf | Effl. |
| PFBA | 7.4 | 7.0 | 4.77 | 7.9 | 7.3 | 4.70 | 7.6 | 2.50 |
| PFBS | 6.5 | 6.2 | 4.23 | 7.9 | 8.0 | 5.10 | 7.0 | 3.90 |
| PFOA | 79 | 64 | 14.00 | 78 | 75 | 23.67 | 70 | 12.67 |
| PFOS | 70 | 0.0 | 0.79 | 65 | 0.0 | 1.05 | 70 | 11.07 |

*Col = pretreatment media column; Inf = influent; Effl. = effluent; MP = membrane permeates.

TABLE 6

| | | | | | | | | | | Removal by | |
|---|---|---|---|---|---|---|---|---|---|---|---|
| | Removal by CPS-nanofiltration (%) | | | | | | | | | ZIPGEM-nanofiltration (%) | |
| | | nanofil- | | | nanofil- | | | nanofil- | | | nanofil- |
| | C1 | tration | O | C2 | tration | O | C3 | tration | O | C1 | tration |
| PFBA | 21 | 47 | 58 | 24 | 28 | 45 | 29 | 33 | 53 | 5 | 37 |
| PFBS | 20 | 26 | 41 | 27 | 15 | 38 | 25 | 35 | 52 | 6 | 23 |
| PFOA | 96 | 40 | 98 | 85 | 58 | 94 | 88 | 78 | 97 | 19 | 66 |
| PFOS | 100 | 100 | 100 | 100 | 100 | 100 | 100 | 100 | 100 | 100 | 100 |

| | | | | | | | | % |
|---|---|---|---|---|---|---|---|---|
| | Removal by | | | | | | | Removal |
| | ZIPGEM-nanofiltration (%) | | | | | | | by |
| | | | nanofil- | | | nanofil- | | Control |
| | O | C2 | tration | O | C3 | tration | O | O |
| PFBA | 40 | 5 | 32 | 36 | 8 | 36 | 41 | 67 |
| PFBS | 28 | 5 | 32 | 35 | −1 | 36 | 35 | 44 |
| PFOA | 73 | 19 | 78 | 82 | 4 | 68 | 70 | 82 |
| PFOS | 100 | 100 | 100 | 100 | 100 | 100 | 100 | 84 |

*C1, C2, C3 = PFAS removals via columns 1, 2, or 3; nanofiltration = nanofiltration membrane removal; O = overall removal by water treatment system.

TABLE 7

| | | Hypothesis Confirmation/ |
|---|---|---|
| | Major Findings | Agreement With |
| 1 | CPS and ZIPGEM media exhibit higher | Alternative hypothesis 1 |
| | removal efficiencies for long-chain | in TABLE 4 |
| | PFAS compared to short-chain PFAS. | |
| 2 | CPS and ZIPGEM media demonstrate | Alternative hypothesis 2 |
| | higher removal efficiencies for | for long-chain PFAS, but |
| | PFOS and PFBA compared to PFOA | does not apply for short- |
| | and PFBS, respectively. | chain PFAS |
| 3 | CPS-nanofiltration hybrid exhibits | Alternative hypothesis 3 |
| | higher removal of long-chain PFAS | |
| | compared to the control. The ZIPGEM- | |
| | nanofiltration system shows higher | |
| | removal only for PFOS. Both water | |
| | treatment systems show poor removal | |
| | of short-chain PFAS compared to the | |
| | control system. | |
| 4 | Enhanced removal of PFAS by CPS and | Alternative hypothesis 4 |
| | ZIPGEM causes reduced removal | |
| | efficiency by nanofiltration only | |
| | when treating the media pretreated | |
| | water. | |

The removal efficiency of long-chain PFAS by both CPS and ZIPGEM media was greater than that for short-chain PFAS, as shown in FIG. 6. The average removal percentages of PFOS, PFOA, PFBS, and PFBA were 100, 90, 24, and 25, respectively, for CPS, and 100, 14, 3.3, and 6, respectively, for ZIPGEM. TABLE 8 presents the ANOVA test results comparing removal efficiencies of long- and short-chain PFAS. The p-values for both the media mixes were less than 0.05, such that the null hypothesis 1 can be rejected, as disclosed in TABLE 4. Therefore, the alternative hypothesis can be accepted that both CPS and ZIPGEM media mixes perform significantly better in removing long-chain PFAS compared to the short-chain PFAS.

TABLE 8

| Comparison | CPS | | ZIPGEM | |
|---|---|---|---|---|
| Long-chain | 3.02 × 10⁻⁰⁸ | | 7.29 × 10⁻⁰⁶ | |
| vs. short- | | | | |
| chain PFAS | | | | |
| | Long-chain | Short-chain | Long-chain | Short-chain |
| | PFAS | PFAS | PFAS | PFAS |
| PFSAs vs. | 0.035 | 0.34 | 0.000067 | 0.33 |
| PFCAs | | | | |

Although FIG. 6 (Section A) indicates that CPS performs better than ZIPGEM in removing PFOA, PFBS, and PFBA, further discussion comparing this performance was deemed not reasonable. This is due to the fact ZIPGEM effluent was collected past its breakpoint, thereby not representing its removal efficiency at the breakpoint. Rather, the comparison between long- and short-chain PFAS removal by each media mix was discussed further.

As shown in FIG. 6 (Section A), the removal efficiency of PFOS was higher than that of PFOA by both media. However, a similar trend was not observed for PFBS vs. PFBA. Rather, PFBA removal by both media was slightly higher than PFBS. The p-value for PFOS vs. PFOA was less than 0.05 for both media, meaning the finding agrees with alternative hypothesis 2 of the ANOVA analysis, as shown in TABLE 4. For the short-chain PFAS, the p-values were greater than 0.05, and, hence, null hypothesis 2 could not be rejected. PFBA removal efficiency was higher than PFBS in all treatments, including green sorption media (CPS and ZIPGEM), water treatment systems (CPS-nanofiltration and ZIPGEM-nanofiltration), and the control. Because the concentration of PFBA was higher in the raw canal water, more interactions with the adsorption media were likely. In the case of membrane treatment, the carboxylic acid functional groups of the polyamide membrane could play a role in higher PFBA removal. For instance, the carboxylic groups of the membrane surface can be linked with the carboxylic acid groups in the bulk water by calcium through cation bridging (Mo et al., 2012).

FIG. 6 (Sections C-D) show the PFAS removal by the CPS-nanofiltration and ZIPGEM-nanofiltration water treatment systems and the control, respectively. As listed in TABLE 4, the integration of pretreatment media would significantly enhance overall PFAS removal efficiency was hypothesized. The one-way ANOVA yielded a p-value of lower than 0.05 for each of the PFAS removal methods except for PFBS, as disclosed in TABLE 9, suggesting one or more groups are significantly different.

TABLE 9

| Source of Variation | F | F-crit | p-value |
|---|---|---|---|
| PFOS | 55.56 | 5.14 | 0.00013 |
| PFOA | 22.48 | 5.14 | 0.0016 |
| PFBS | 3.78 | 5.14 | 0.087 |
| PFBA | 21.82 | 5.14 | 0.0018 |

| | Tukey HSD p-value for pair-wise comparison | | | |
|---|---|---|---|---|
| | PFOS | PFOA | PFBS | PFBA |
| CPS-nanofiltration vs. | 0.8999 | 0.0014 | 0.1281 | 0.0497 |
| ZIPGEM-nanofiltration | | | | |
| CPS-nanofiltration | 0.0010 | 0.0104 | 0.8999 | 0.0285 |
| vs. Control | | | | |
| ZIPGEM-nanofiltration | 0.0010 | 0.1613 | 0.1109 | 0.0014 |
| vs. Control | | | | |

TABLE 9 shows that, in terms of PFOS removal, there was no significant difference between both water treatment systems (p>0.05). However, a significant difference exists between removals by hybrid and control systems. For PFOA removal, only ZIPGEM-nanofiltration vs. the control pair shows significant differences. For PFBS, no pair shows any statistically significant differences in the removal efficiencies. For PFBA, p-values are less than 0.05 for all the treatment pairs, indicating significant differences in the removal efficiencies. There were significant differences in PFOS and PFOA removal efficiencies by CPS-nanofiltration when compared to that of the control (p<0.05). It was shown in FIG. 6 (Section C) that the removal efficiencies of PFOS and PFOA by CPS-nanofiltration were significantly higher than that of the control. When comparing ZIPGEM-nanofiltration vs. the control, the overall removal efficiency of PFOS was significantly higher than ZIPGEM-nanofiltration, but that of PFOA was not statistically significant. This can be attributed to the fact that ZIPGEM becomes exhausted after 30 h of operation, and so no significant removal of PFOA could be achieved. Hence, when comparing with the control, the overall removal efficiency of the water treatment system reported here could be credited mostly to the nanofiltration membrane.

When considering the short-chain PFAS, PFBS removal efficiency by both the water treatment systems was insignificant compared to the control (p>0.05). However, the PFBA removal efficiency was significantly higher by the control compared to the water treatment systems (See FIG. 6 (Sections C-D)). It should be noted PFBA removal efficiencies were higher than PFBS in all of the treatment schemes. This can be attributed to the difference in the initial concentrations of PFBS and PFBA because the latter had a higher concentration in the raw canal water, suggesting an effect of initial concentration on short-chain PFAS removal by green sorption media and nanofiltration. From the above statistical analyses, the third null hypothesis can be rejected, thereby concluding that there were significant differences in PFAS removal efficiencies between the water treatment system and the control.

As shown in FIG. 6 (Section B), when PFAS removal by CPS or ZIPGEM pretreatment is high (i.e., the PFAS concentrations in the nanofiltration feed are low), nanofiltration removal efficiency decreases significantly. The long-chain PFAS like PFOS and PFOA can form micelles (Lyu et al., 2022) that can lead to higher removal by the membrane; however, if PFAS concentrations decrease, the likelihood of PFAS molecules passing through the membrane pores increases. As depicted in FIG. 7, green sorption media-based pretreatment can remove NOM and background cations like Ca²⁺, which may act as positive catalysts for the removal of PFAS using nanofiltration (Meng et al., 2020; Olimattel et al., 2021; Toure & Sadmani, 2019). If NOM and divalent cations are removed by the green sorption media, there will be less “cation bridging” (See FIG. 7) that would have kept the PFAS molecules in the bulk water with NOM, allowing more PFAS-membrane interactions and leading to lower removal by the membrane. Yet membrane pore shielding by divalent cations and the shrinking of pores by foulants can increase removal. Therefore, the removal of NOM and cations from the water matrix by green sorption media-based pretreatment leads to lower removal efficiency of PFAS by subsequent membrane treatment.

The ANOVA test result shows the p-values for all the PFAS are less than 0.05, except for PFOA by CPS and PFBS by ZIPGEM media, as shown in TABLE 10. The effluent concentration of PFOA after 30 h of ZIPGEM pretreatment was high, which was followed by high removal efficiency by the membrane. Again, low removal of PFBS by ZIPGEM media resulted in and compensated for the high removal efficiency of the compound by the membrane. This confirms the fourth alternative hypothesis that there was a significant difference between the removal efficiencies of the membrane across the water treatment system and the control.

TABLE 10

| Source of | CPS | | | ZIPGEM | | |
|---|---|---|---|---|---|---|
| Variation | F | F-crit | p-value | F | F-crit | p-value |
| PFOS | 55.56 | 7.70 | 0.0017 | 55.56 | 5.14 | 0.0017 |
| PFOA | 4.45 | 7.70 | 0.10 | 8.60 | 5.14 | 0.042 |
| PFBS | 8.09 | 7.70 | 0.047 | 7.56 | 5.14 | 0.051 |
| PFBA | 22.34 | 7.70 | 0.0091 | 77.72 | 5.14 | 0.00091 |

For any adsorption media, the two key underlying adsorption mechanisms at play are hydrophobic interaction and electrostatic interaction (Riegel et al., 2023). The hydrophobic interaction depends on the surface chemistry of the adsorbent and the hydrophobicity of the adsorbate, whereas the electrostatic interaction depends on the charges of the adsorbent and adsorbate (Deng et al., 2015). PFAS compounds that are predominantly hydrophobic in nature, especially the long-chain PFOS and PFOA, are removed through hydrophobic interaction by both media. However, the short-chain PFAS such as PFBS and PFBA are much less hydrophobic and have higher solubility in water. Therefore, their removal is governed by electrostatic interaction.

Both pretreatment media contain metals embedded on the surface of the silica. The canal water has a pH close to 7, which is higher than the experimentally measured point of zero charge (PZC) of CPS (5.6±0.22) and less than that of ZIPGEM (9.2±0.33). Therefore, upon contact with the water, the surface of the media CPS becomes negatively charged, whereas the ZIPGEM media surface acquires positive charge. ZVI (zero valent iron) in ZIPGEM facilitates PFAS removal through not only adsorption but also reductive degradation and complexation (Ordonez et al., 2022). Furthermore, the inclusion of ZVI (PZC around 7.7) led to a higher point of zero charge of ZIPGEM, offering an edge over CPS in terms of PFAS removal performance (Zhou et al., 2014).

PFAS compounds remain as anions in the water matrix at an environmentally relevant pH (pH=7; Lyu et al., 2022). This implies electrostatic interaction plays a significant role along with hydrophobic interaction for ZIPGEM media, whereas, for CPS, the removal mechanism is mostly hydrophobic interaction. Both the hydrophobic and electrostatic interactions contribute to the removal of long-chain PFAS such as PFOS and PFOA. However, hydrophobic interactions may be less influential in the case of PFBA or PFBS due to their short hydrophobic tails. As per the Log D values, as shown in TABLE 1, PFOS is more hydrophobic (Log D>2.0) compared to the rest of the PFAS selected. Therefore, hydrophobic interaction contributes more toward PFOS adsorption compared to PFOA and shorter-chain PFAS (Zhang et al., 2021). Initially, both PFOS and PFOA compete for the adsorption sites through hydrophobic and electrostatic interaction; however, as time progresses, both media show poor removal of PFOA and the short-chain PFAS. This can be attributed to the electrostatic repulsion between PFOA and the media surface that becomes negatively charged progressively.

Because hydrophobic interactions depend on the property of the adsorbate, it is likely the PFOS molecules continue to be removed by the media via this mechanism. Once an adsorption site is occupied by a PFOS molecule, PFOA cannot evict that PFOS molecule because it is attached by a stronger hydrophobic interaction. Moreover, PFOS can replace PFOA and can also be adsorbed onto the media in the case of multilayer adsorption (Bei et al., 2014). Therefore, the competition for adsorption sites increases with time, and PFOA tends to desorb from its monolayer. When all the adsorption sites are occupied by PFOS and the background anions (NOM, HCO₃⁻, SO₄²⁻, etc.), both media including ZIPGEM may become shielded by negatively charged entities.

At this point, PFOA or any shorter-chain PFAS (e.g., PFBA, PFBS) not only face competition for adsorption sites but also are less likely to be removed because of electrostatic repulsion by both media. This explains why PFOA removal is poor by ZIPGEM after 30 h compared to CPS at 9 h (See FIG. 6 (Section A)). Thus, the presence of long chain-PFAS can suppress the adsorption of shorter-chain PFAS. Divalent cations act as a positive catalyst, whereas NOM acts as a negative catalyst for PFAS adsorption onto a negative surface (Yin & Villagrán, 2022). Cations like Ca²⁺ neutralize the negative charge of NOM in bulk water, which otherwise would take the place of PFAS in adsorption media (Davis & Edwards, 2017; Y. Zhang et al., 2009). Moreover, Ca²⁺ binds with anionic PFAS and helps them adsorb on the media surface. Other mechanisms, such as entrapment and hydrogen bonding (See FIG. 7), also contribute to the PFAS adsorption process. Further research should be conducted to determine the individual and synergistic contributions of the media constituents, including SiO₂, Al₂SiO₅, Al₂O₃, and Fe₂O₃(FIGS. 1 and 2) on PFAS adsorption behavior.

The dominant PFAS removal mechanism by tight nanofiltration membrane is size exclusion. The nanofiltration membrane with MWCO of 500 Da was selected, so the effect of the PFAS interactions with green sorption media pretreated water constituents on membrane removal—rather than only the sieving mechanism—could be studied. Furthermore, the selected membrane has a polyamide network in its structure containing carboxylic acid functional groups (R—COOH/R—COO⁻; Ritt et al., 2020). Because anionic PFAS with small pKa values remain in deprotonated form at pH 7, electrostatic repulsion plays an important role in their removal by the membrane (Lyu et al., 2022). The charge density on the surface of the membrane can depend on a variety of factors, including pH and the ionic strength of bulk water. Higher charge density exerts higher electrostatic repulsion, resulting in higher removal of PFAS.

Although size exclusion is the dominant removal mechanism for long-chain PFAS, the Donnan exclusion mechanism predominates in the case of the short-chain PFAS (Liu et al., 2022). Divalent cations in the water matrix facilitate PFAS removal by shielding membrane pores and via cation-bridging (Cai et al., 2022; See FIG. 8). The indigenous NOM in the bulk water can bind with PFAS by cation-bridging, consequently increasing PFAS removal by the membrane. Unlike the long-chain PFAS that can be removed predominantly by the size exclusion mechanism because their molecular size is close to the MWCO of the membrane, the removal of short-chain PFAS is dependent on electrostatic interaction because they tend to pass through the membrane pores due to their low molecular size. The electrostatic interaction can facilitate the formation of cation bridging between divalent cations and their functional groups, which can thwart their diffusion through the membrane pores. Moreover, divalent cations tend to form complex chemicals between PFAS and NOM through cation bridging between their functional groups. Therefore, short-chain PFAS can be removed via the size exclusion mechanism when they are bonded with NOM.

Furthermore, cations can form cross-linking bonds between carboxylic groups of organic matter and that of membranes (Nickerson et al., 2023). This phenomenon can explain why PFBA shows higher removal than PFBS. Additionally, a greater concentration of PFBA in the influent leads to a more complex formation with divalent cations and NOM, as well as cross-linking, which in turn can lead to higher removal compared to PFBS. However, further investigation with identical influent concentration of PFBA and PFBS should be conducted to verify whether the cross-linking mechanism is exclusive to carboxylic compounds. One key finding is that low concentration of PFAS in the nanofiltration feedwater, due to the high efficiency of PFAS and other water constituent removal by green sorption media that precedes nanofiltration, is followed by low removal efficiency of the compounds by the membrane. This can be attributed to the fact that, at low concentration, the compounds are less likely to form aggregates (micelle or hemimicelle) with themselves or with other water constituents, leading to reduced retention by the membrane (less size exclusion).

As discussed earlier, the integration of green sorption media pretreatment improves the overall removal efficiency of long-chain PFAS via the water treatment system. green sorption media-based media mixes perform poorly in removing the short-chain PFAS. Although the membrane removal efficiency for short-chain PFAS was significant in the control, it was insignificant when integrated with green sorption media pretreatment. This can be ascribed to the fact that green sorption media pretreatment removes the NOM and divalent cations, which do not have a major effect on long-chain PFAS removal because they can be removed through size exclusion. However, green sorption media pretreatment significantly affects the removal of short-chain PFAS. Unlike long-chain PFAS, the short-chain PFAS are soluble and tend to remain in bulk water with cations and NOM. Therefore, removing NOM and cations causes reduced removal of short-chain PFAS. Moreover, the removal of anions and cations by the pretreatment media reduces the ionic strength of the water, leading to reduced charge density of the polyamide membrane and consequently reducing electrostatic repulsion between the short-chain PFAS and the membrane surface. As a result, the short-chain PFAS may easily pass through the membrane pores.

This finding indicates that the influent concentration of PFAS directly affects the removal efficiency of PFAS via nanofiltration. The significant removal of PFAS by green sorption media pretreatment may lead to reduced removal by the nanofiltration unit compared to that by nanofiltration without green sorption media pretreatment was revealed. However, when PFAS concentrations in the pretreatment media effluent are high, their removal efficiency by only the membrane increases significantly. Therefore, it can be concluded that PFAS removal efficiency by nanofiltration in the water treatment system depends on the influent (raw water) concentration. In addition, findings indicate that the pretreatment media did not remove PFBA and PFBS (short-chain PFAS) effectively. However, when green sorption media pretreatment is integrated with the nanofiltration as a practicable comprehensive water treatment scheme, the overall short-chain PFAS removal efficiency becomes significantly higher. Therefore, for the removal of short-chain PFAS, the green sorption media-nanofiltration water treatment system always renders higher removal efficiency compared to when the media or the membrane are applied individually.

In addition to offering PFAS removal from the source water, the green sorption media was intended to serve as a cost-effective and sustainable means of reducing the fouling of the nanofiltration membrane. To evaluate the effect of CPS and ZIPGEM pretreatment on fouling, nanofiltration permeate flux was monitored over a period of 24 h and compared with the permeate flux when filtering the raw canal water without pretreatment. The filtration experiment was conducted in recirculation mode at a transmembrane pressure of 100 psi and cross flow velocity of 0.18 m·s⁻¹ (Higgins & Duranceau, 2020; Zebić Avdičević et al., 2019). FIG. 9 (Section A) shows the fluxes that permeate as a function of time. When the canal water was pretreated with CPS or ZIPGEM, the nanofiltration permeate was higher and the decline in permeate flux was less compared to filtering the canal water without pretreatment. However, it is not significantly greater than that of treated water. As shown in FIG. 9 (Sections B-D), the green sorption media can significantly reduce the concentrations of Ca²⁺, TOC, and DOC from the source water, which has great potential to reduce membrane fouling (Uyak et al., 2014).

An ANOVA test was performed to determine whether fouling of the nanofiltration membrane was significantly reduced by green sorption media-based pretreatment. TABLE 11 presents the ANOVA test results. Because the p-value is greater than 0.05, the null hypothesis must be accepted, and, therefore, it can be concluded that, although the pretreatment improved water quality by removing cations and NOM and reduced membrane fouling, the reduction was not statistically significant.

TABLE 11

| Source | F statistics | p-value |
|---|---|---|
| ZIPGEM vs. Control | 0.14 | 0.71 |
| CPS vs. Control | 0.26 | 0.62 |

This could be due to the fact that the selected membrane is a rather loose nanofiltration membrane, and therefore, it is expected to encounter less fouling compared to tighter nanofiltration or RO membranes. Other factors including low transmembrane pressure (Sillanpaa et al., 2015), tangential nature of filtration (Li et al., 2019), negative surface charge of membrane (Virga et al., 2021), and low concentrations of foulants in the source water (FIGS. 9b, 9c and 9d) may have alleviated flux decline. Hence, no pronounced variation in permeate flux between the control and pretreated water was observed.

### CONCLUSION

The primary goal was to determine the effects of pretreatment by two specialty adsorbents on the nanofiltration of selected long- and short-chain PFAS. The effect of green sorption media-pretreated water matrix properties on nanofiltration removal of PFAS was also investigated, and the overall PFAS removal efficiencies of the green sorption media-nanofiltration hybrid processes were evaluated. When comparing the long- and short-chain PFAS, the specialty adsorbents (namely, CPS and ZIPGEM) exhibit significantly higher removal of the long-chain PFAS (PFOS and PFOA) rather than the short-chain ones (PFBA and PFBS). The removal efficiencies of PFBA were higher than those of PFBS in all treatment schemes, attributable to the higher concentration of PFBA in the raw canal water. The dominant mechanism of removal of PFOS (more hydrophobic compared to the rest of the PFAS studied) by the media was hydrophobic interaction, whereas that of PFOA and the short-chain PFAS was electrostatic interaction between those PFAS and the media.

When compared to the control, the CPS-nanofiltration and ZIPGEM-nanofiltration hybrid processes exhibited significantly higher removal of the long-chain PFAS, except for PFOA (not statistically significant). Higher efficiency of CPS and ZIPGEM in removing the long-chain PFAS, in addition to NOM and Ca²⁺ (which serve as positive catalysts in PFAS removal), leads to lower removal efficiency of nanofiltration in the water treatment system compared to the control. This can be attributed to the reduction in concentrations of NOM and cations, and that of PFOS and PFOA molecules by the green sorption media, possibly leading to less calcium bridging and less micelle/complex formation by PFOS/A in bulk water, respectively. Although green sorption media mixes perform poorly in removing the short-chain PFAS (PFBA and PFBS), the integration of green sorption media with nanofiltration results in significantly enhanced PFAS removal efficiency by the water treatment system. Hence, when the pretreatment media fails to remove PFAS effectively (e.g., short-chain PFAS, upon media exhaustion), the membrane plays a significant role in the overall removal efficiency.

green sorption media pretreatment not only offers PFAS removal from source waters but also serves as a cost-effective and sustainable means of reducing nanofiltration membrane fouling/scaling by removing NOM and cations from water. Thus, the green sorption media-nanofiltration water treatment systems demonstrate great potential for removing long- and short-chain PFAS from various water matrices. Further investigation is required to determine whether regenerating the media would be cost-effective when considering both the lifespan and low cost of media preparation. Furthermore, future researchers should focus on enhancing the removal efficiency of short-chain PFAS via the water treatment system.

The green sorption media recipe can be modified to fine-tune the selectivity for short-chain PFAS while maintaining the membrane fouling mitigation potential. Besides, selecting a membrane with higher negative charge may facilitate higher removal of short-chain PFAS. Moreover, running the crossflow nanofiltration at a higher crossflow velocity will mitigate the concentration polarization effect, consequently limiting any diffusion of short-chain PFAS through the membrane matrix (Das & Ronen, 2022). Additionally, the effect of membrane surface functionalization on PFAS removal (Olimattel et. al., 2021) using the water treatment system should be further investigated so the membrane flux is not compromised while targeting enhanced PFAS removal efficiency.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Alves, A. V., Tsianou, M., & Alexandridis, P. (2020). Fluorinated Surfactant Adsorption on Mineral Surfaces: Implications for PFAS Fate and Transport in the Environment. Surfaces, 3(4), 516-566.
Andrews, D. Q., & Naidenko, O. V. (2020). Population-Wide Exposure to Per- and Polyfluoroalkyl Substances from Drinking Water in the United States. Environmental Science & Technology Letters, 7(12), 931-936.
Bei, Y., Deng, S., Du, Z., Wang, B., Huang, J., & Yu, G. (2014). Adsorption of perfluorooctane sulfonate on carbon nanotubes: Influence of pH and competitive ions. Water Science and Technology: A Journal of the International Association on Water Pollution Research, 69(7), 1489-1495. PRIME.
Blake, B. E., & Fenton, S. E. (2020). Early life exposure to per- and polyfluoroalkyl substances (PFAS) and latent health outcomes: A review including the placenta as a target tissue and possible driver of peri- and postnatal effects. Toxicology, 443, 152565.
Bossart, G. D. (2011). Marine mammals as sentinel species for oceans and human health. Veterinary Pathology, 48(3), 676-690.
Buckley, T., Karanam, K., Han, H., Vo, H. N. P., Shukla, P., Firouzi, M., & Rudolph, V. (2023). Effect of different co-foaming agents on PFAS removal from the environment by foam fractionation. Water Research, 230, 119532.
Cai, W., Navarro, D., Du, J., Ying, G., Yang, B., McLaughlin, M., & Kookana, R. (2022). Increasing ionic strength and valency of cations enhance sorption through hydrophobic interactions of PFAS with soil surfaces. Science of The Total Environment, 817, 152975.
Das, S., & Ronen, A. (2022). A Review on Removal and Destruction of Per- and Polyfluoroalkyl Substances (PFAS) by Novel Membranes. Membranes, 12(7).
Davis, C. C., & Edwards, M. (2017). Role of Calcium in the Coagulation of NOM with Ferric Chloride. Environmental Science & Technology, 51(20), 11652-11659.
Deng, S., Bei, Y., Lu, X., Du, Z., Wang, B., Wang, Y., Huang, J., & Yu, G. (2015). Effect of co-existing organic compounds on adsorption of perfluorinated compounds onto carbon nanotubes. Frontiers of Environmental Science & Engineering, 9(5), 784-792.
Fenton, S. E., Ducatman, A., Boobis, A., DeWitt, J. C., Lau, C., Ng, C., Smith, J. S., & Roberts, S. M. (2021). Per- and Polyfluoroalkyl Substance Toxicity and Human Health Review: Current State of Knowledge and Strategies for Informing Future Research. Environmental Toxicology and Chemistry, 40(3), 606-630. PubMed.
Gagliano, E., Sgroi, M., Falciglia, P. P., Vagliasindi, F. G. A., & Roccaro, P. (2020). Removal of poly- and perfluoroalkyl substances (PFAS) from water by adsorption: Role of PFAS chain length, effect of organic matter and challenges in adsorbent regeneration. Water Research, 171, 115381.
Griffin, E. K., Aristizabal-Henao, J., Timshina, A., Ditz, H. L., Camacho, C. G., Silva, B. F. da, Coker, E. S., Quinones, K. Y. D., Aufmuth, J., & Bowden, J. A. (2022). Assessment of per- and polyfluoroalkyl substances (PFAS) in the Indian River Lagoon and Atlantic coast of Brevard County, FL, reveals distinct spatial clusters. Chemosphere, 301, 134478.
Hallé, C. (2023). Biofiltration in Drinking Water Treatment: Reduction of Membrane Fouling and Biodegradation of Organic Trace Contaminants.
Haukås, M., Berger, U., Hop, H., Gulliksen, B., & Gabrielsen, G. W. (2007). Bioaccumulation of per- and polyfluorinated alkyl substances (PFAS) in selected species from the Barents Sea food web. Environmental Pollution, 148(1), 360-371.
Higgins, C. J., & Duranceau, S. J. (2020). Removal of Enantiomeric Ibuprofen in a Nanofiltration Membrane Process. Membranes, 10(12).
Inyang, M., & Dickenson, E. R. V. (2017). The use of carbon adsorbents for the removal of perfluoroalkyl acids from potable reuse systems. Chemosphere, 184, 168-175.
Li, Q., Reeve, C., Martinez, L., & Wright, S. (2019). 2.62—Scale-up in Biotechnology. In M. Moo-Young (Ed.), Comprehensive Biotechnology (Third Edition) (Third Edition, pp. 919-932). Pergamon.
Liu, Y., Li, T., Bao, J., Hu, X., Zhao, X., Shao, L., Li, C., & Lu, M. (2022). A Review of Treatment Techniques for Short-Chain Perfluoroalkyl Substances. Applied Sciences, 12(4).
Lynch, K. M., Fair, P. A., Houde, M., Muir, D. C. G., Kannan, K., Bossart, G. D., Bartell, S. M., & Gribble, M. O. (2019). Temporal Trends in Per- and Polyfluoroalkyl Substances in Bottlenose Dolphins (Tursiops truncatus) of Indian River Lagoon, Florida and Charleston, South Carolina. Environmental Science & Technology, 53(24), 14194-14203.
Lyu, X., Xiao, F., Shen, C., Chen, J., Park, C. M., Sun, Y., Flury, M., & Wang, D. (2022). Per- and Polyfluoroalkyl Substances (PFAS) in Subsurface Environments: Occurrence,
Fate, Transport, and Research Prospect. Reviews of Geophysics, 60(3), e2021RG000765.
MarvinSketch. (2023). Marvin version 23.4, 2023, ChemAxon (http://www.chemaxon.com). (n.d.). Retrieved Mar. 27, 2023, from https://chemaxon.com/marvin
Meng, F., Song, F., Yao, Y., Liu, G., & Zhao, S. (2020). Ultrastable Nanofiltration Membranes Engineered by Polydopamine-Assisted Polyelectrolyte Layer-by-Layer Assembly for Water Reclamation. ACS Sustainable Chemistry & Engineering, 8(29), 10928-10938.
Nickerson, T. R., Antonio, E. N., McNally, D. P., Toney, M. F., Ban, C., & Straub, A. P. (2023). Unlocking the potential of polymeric desalination membranes by understanding molecular-level interactions and transport mechanisms. Chemical Science, 14(4), 751-770.
OECD, 2023. (n.d.). Retrieved May 8, 2023, from https://www.oecd.org/chemicalsafety/portal-perfluorinated-chemicals/aboutpfass/
Olimattel, K., Zhai, L., & Sadmani, A. H. M. A. (2021). Enhanced removal of perfluorooctane sulfonic acid and perfluorooctanoic acid via polyelectrolyte functionalized ultrafiltration membrane: Effects of membrane modification and water matrix. Journal of Hazardous Materials Letters, 2, 100043.
Ordonez, D., Podder, A., Valencia, A., Sadmani, A. H. M. A., Reinhart, D., & Chang, N.-B. (2022). Continuous fixed-bed column adsorption of perfluorooctane sulfonic acid (PFOS) and perfluorooctanoic acid (PFOA) from canal water using zero-valent Iron-based filtration media. Separation and Purification Technology, 299, 121800.
Ordonez, D., Valencia, A., Elhakiem, H., Chang, N.-B., & Wanielista, M. P. (2020). Adsorption thermodynamics and kinetics of Advanced Green Environmental Media (AGEM) for nutrient removal and recovery in agricultural discharge and stormwater runoff. Environmental Pollution, 266, 115172.
Palma, D., Papagiannaki, D., Lai, M., Binetti, R., Sleiman, M., Minella, M., & Richard, C. (2021). PFAS Degradation in Ultrapure and Groundwater Using Non-Thermal Plasma. Molecules (Basel, Switzerland), 26(4).
Riegel, M., Haist-Gulde, B., & Sacher, F. (2023). Sorptive removal of short-chain perfluoroalkyl substances (PFAS) during drinking water treatment using activated carbon and anion exchanger. Environmental Sciences Europe, 35(1), 12.
Ritt, C. L., Werber, J. R., Wang, M., Yang, Z., Zhao, Y., Kulik, H. J., & Elimelech, M. (2020). Ionization behavior of nanoporous polyamide membranes. Proceedings of the National Academy of Sciences, 117(48), 30191-30200.
Sadmani, A. H. M. A., Andrews, R. C., & Bagley, D. M. (2014). Influence of naturally occurring dissolved organic matter, colloids, and cations on nanofiltration of pharmaceutically active and endocrine disrupting compounds. Chemosphere, 117, 170-177.
Sillanpää, M., Metsämuuronen, S., & Mänttäri, M. (2015). Chapter 5—Membranes. In M. Sillanpää (Ed.), Natural Organic Matter in Water (pp. 113-157). Butterworth-Heinemann.
Sleep, J. A., Miklavcic, S. J., & Juhasz, A. L. (2023). Modelling of PFAS-surface interactions: Effect of surface charge and solution ions. Chemosphere, 319, 137910.
Suhalim, N. S., Kasim, N., Mahmoudi, E., Shamsudin, I. J., Mohammad, A. W., Mohamed Zuki, F., & Jamari, N. L.-A. (2022). Rejection Mechanism of Ionic Solute Removal by Nanofiltration Membranes: An Overview. Nanomaterials, 12(3).
Toure, H., & Anwar Sadmani, A. H. M. (2019). Nanofiltration of perfluorooctanoic acid and perfluorooctane sulfonic acid as a function of water matrix properties. Water Supply, 19(8), 2199-2205.
U.S. Army Corps of Engineers, 2023. (n.d.). Retrieved Mar. 27, 2023, from https://www.saj.usace.army.mil/IRLSC23C24/.
Uyak, V., Akdagli, M., Cakmakci, M., & Koyuncu, I. (2014). Natural Organic Matter Removal and Fouling in a Low Pressure Hybrid Membrane Systems. The Scientific World Journal, 2014, 893203.
Virga, E., Žvab, K., & Vos, W. M. de. (2021). Fouling of nanofiltration membranes based on polyelectrolyte multilayers: The effect of a zwitterionic final layer. Journal of Membrane Science, 620, 118793.
Yang, Q., Zhang, X., Xu, X., & Asrar, G. R. (2017). An Analysis of Terrestrial and Aquatic Environmental Controls of Riverine Dissolved Organic Carbon in the Conterminous United States. Water, 9(6).
Yin, S., & Villagrán, D. (2022). Design of nanomaterials for the removal of per- and poly-fluoroalkyl substances (PFAS) in water: Strategies, mechanisms, challenges, and opportunities. Science of The Total Environment, 831, 154939.
Zebić Avdičević, M., Kosutic, K., & Dobrović, S. (2019). Flux Decline Study of Tubular Ceramic and Flat Sheet UF Membranes in Textile Wastewater Treatment. Chemical and Biochemical Engineering Quarterly, 33.
Zhang, Y., Chen, Y., Westerhoff, P., & Crittenden, J. (2009). Impact of natural organic matter and divalent cations on the stability of aqueous nanoparticles. Water Research, 43(17), 4249-4257.
Zhang, Z., Sarkar, D., Datta, R., & Deng, Y. (2021). Adsorption of perfluorooctanoic acid (PFOA) and perfluorooctanesulfonic acid (PFOS) by aluminum-based drinking water treatment residuals. Journal of Hazardous Materials Letters, 2, 100034.
Zhou, Y., Gao, B., Zimmerman, A. R., Chen, H., Zhang, M., & Cao, X. (2014). Biochar-supported zerovalent iron for removal of various contaminants from aqueous solutions. Bioresource Technology, 152, 538-542.
Huang, Z., Gong, B., Huang, C.-P., Pan, S.-Y., Wu, P., Dang, Z., & Chiang, P.-C. (2019, 2019 Feb. 1). Performance evaluation of integrated adsorption-nanofiltration system for emerging compounds removal: Exemplified by caffeine, diclofenac and octylphenol. Journal of Environmental Management, 231, 121-128.
Imbrogno, A., Tiraferri, A., Abbenante, S., Weyand, S., Schwaiger, R., Luxbacher, T., & Schäfer, A. I. (2018, 2018/03/01/). Organic fouling control through magnetic ion exchange-nanofiltration (MIEX-NF) in water treatment. Journal of Membrane Science, 549, 474-485.
Lee, S., & Lee, C. H. (2006, 2006/01/01). Microfiltration and Ultrafiltration As a Pretreatment For Nanofiltration of Surface Water. Separation Science and Technology, 41(1), 1-23.
Yu, H.-B., Zhang, X.-Q., Han, X., Yang, Z.-Z., Zhou, Y.-W., Ding, W., & Du, M.-X. (2021, 2021 Dec. 18). Nanofiltration Membrane Fouling and Control Caused by Residual Aluminum in Feed Water. Water, Air, & Soil Pollution, 233(1), 1.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A water treatment system for removing per-fluoroalkyl substances, polyfluoroalkyl substances, or both from a fluid, the water treatment system comprising:
a filtration chamber for pretreating the fluid, the filtration chamber including a green sorption media;
a crossflow nanofiltration chamber fluidically coupled to the filtration chamber, the crossflow nanofiltration chamber comprising at least one nanofiltration membrane and centrifugal pump;
wherein the filtration chamber is in mechanical communication, fluidic communication, or both with the crossflow nanofiltration chamber; and
wherein subsequent to pretreating the fluid, the filtration chamber transports the pretreated fluid to the crossflow nanofiltration chamber, whereby the crossflow chamber is configured to receive pretreated fluid from the filtration chamber and filter the pretreated fluid through the at least one nanofiltration membrane, via the centrifugal pump.

2. The water treatment system of claim 1, wherein the green sorption media comprises a mixture of sand particles of about 85 vol %, clay particles of about 5 vol %, or both.

3. The water treatment system of claim 2, wherein the green sorption media further comprises perlite particles of about 5 vol %.

4. The water treatment system of claim 3, wherein the filtration media further comprises zero-valent iron (hereinafter “ZVI”) particles of at most 5 vol %.

5. The water treatment system of claim 4, wherein the plurality of ZVI are disposed about at least one portion of an outer surface of the green sorption media.

6. The water treatment system of claim 5, wherein the green sorption media exhibit a point of zero charge (hereinafter “PZC”) of about 5.2 to about 9.6.

7. The water treatment system of claim 6, wherein the green sorption media is hydrophobic.

8. The water treatment system of claim 1, wherein the crossflow nanofiltration chamber further comprises a feed tank.

9. The water treatment system of claim 8, wherein the filtration chamber is configured to receive the fluid from the feed tank and pretreat the fluid, via the green sorption media.

10. The water treatment system of claim 9, wherein the fluid is translated through the green sorption media, whereby a first portion of per-fluoroalkyl substances, polyfluoroalkyl substances, or both are adsorbed within at least one portion of a surface of the green sorption media.

11. The water treatment system of claim 10, further comprising a plurality of divalent cations disposed about at least one portion of the filtration chamber, the crossflow nanofiltration chamber, or both.

12. The water treatment system of claim 11, wherein at least one of the plurality of divalent cations is disposed about at least one portion of a surface of the at least one nanofiltration membrane, whereby at least one of a plurality of pores disposed on the surface of the at least one nanofiltration membrane is shielded.

13. The water treatment system of claim 12, wherein the crossflow nanofiltration chamber further comprises a plurality of flowmeters, whereby the plurality of flowmeters are configured to monitor the rate of water translation through the crossflow nanofiltration chamber to optimize filtration, via the at least one nanofiltration membrane.

14. A method of removing perfluoroalkyl substances, polyfluoroalkyl substances, or both from a fluid, the method comprising:
mixing a green sorption media having sand particles of about 85 vol %, clay particles of about 5 vol %, and perlite particles of about 5 vol %;
disposing an amount of the green sorption media into a filtration chamber;
pretreating, via the green sorption media, an amount of fluid containing perfluoroalkyl substances, polyfluoroalkyl substances, or both, to remove a first portion of perfluoroalkyl substances, polyfluoroalkyl substances, or both from the fluid, thereby generating a pretreated fluid;
receiving, via a crossflow nanofiltration chamber in mechanical communication, fluidic communication, or both to the filtration chamber, the pretreated fluid; and
filtering, via at least one nanofiltration membrane of the crossflow nanofiltration chamber, the pretreated fluid to remove a second portion of perfluoroalkyl substances, polyfluoroalkyl substances, or both from the pretreated fluid.

15. The method of claim 14, wherein the filtration media further comprises a plurality of zero-valent iron (hereinafter “ZVI”) particles of at most 5 vol %.

16. The method of claim 15, wherein the plurality of ZVI are disposed about at least one portion of an outer surface of the green sorption media.

17. The method of claim 16, wherein the green sorption media exhibits a point of zero charge (hereinafter “PZC”) of about 5.2 to about 9.6.

18. The method of claim 17, wherein the green sorption media is hydrophobic.

19. The method of claim 14, further comprising the step of, disposing a plurality of divalent cations about at least one portion of the filtration chamber, the crossflow nanofiltration chamber, or both.

20. The method of claim 19, further comprising the step of, subsequent to disposing a plurality of divalent cations about at least one portion of the filtration chamber, the crossflow nanofiltration chamber, or both, shielding, via at least one of the plurality of divalent cations, at least one of a plurality of pores disposed about a surface of the at least one nanofiltration membrane.
